(19) United States
(12) Patent Application Publication
(10) Pub. No.: US 2026/0194626 A1
(43) Pub. Date: Jul. 9, 2026

(54) TRANSMIT AND RECEIVE TECHNIQUES FOR TERAHERTZ SENSING SYSTEMS

(71) Applicant: TeraDar, Inc., Boston, MA (US)

(72) Inventors: Nicholas Saiz, San Jose, CA (US); Tyler Ross, San Diego, CA (US); Gregory L. Charvat, Guilford, CT (US); Matthew Carey, Watertown, MA (US)

(73) Assignee: TeraDar, Inc., Boston, MA (US)

(21) Appl. No.: 19/440,431

(22) Filed: Jan. 5, 2026

Related U.S. Application Data
(60) Provisional application No. 63/742,179, filed on Jan. 6, 2025.

(51) Int. Cl. G01S 7/03; G01S 7/282; G01S 7/295; G01S 13/93

(52) U.S. Cl. CPC G01S 7/036; G01S 7/282; G01S 7/295; G01S 13/93

(57) ABSTRACT

Aspects of the present disclosure improve operating efficiency of a Terahertz RADAR device, facilitating implementation of Terahertz RADAR on a low power budget. Some aspects of the present disclosure relate to regulating a bias state of a harmonic generation circuit in a receiver and/or transmitter of a Terahertz RADAR device. Some aspects of the present disclosure relate to coupling frequency multipliers between RF amplifiers and RF antennas in a transmitter of a Terahertz RADAR device. Some aspects of the present disclosure relate to frequency multipliers, e.g., in a transmitter of a Terahertz RADAR device, using certain transistor configurations (e.g., common-collector or common-drain). A THz RADAR device May implement one, two, or all three of these aspects.

### RELATED APPLICATIONS

This application claims the benefit under 35 U.S.C. § 119 (e) of U.S. Provisional Patent Application Ser. No. 63/742,179, filed Jan. 6, 2025, under Attorney Docket No.: F0869.70006US00, and entitled, “TRANSMIT AND RECEIVE TECHNIQUES FOR TERAHERTZ SENSING SYSTEMS,” which is hereby incorporated herein by reference in its entirety.

### BACKGROUND

Most vehicles available today are equipped with sensors capable of sensing the surrounding environment, which helps drivers operate vehicles more safely in difficult driving situations, contributing significantly to the reduction of vehicle-related accidents such as collisions. It is expected that the use of advanced sensing technologies will accelerate across all segments of the vehicle market, which will help significantly reduce vehicle-related accidents, resulting in fewer injuries and fatalities. It is also expected that the use of advanced sensing technologies at all levels of automation within the vehicle market will make mass implementation of automated vehicles safer. The development and deployment of advanced vehicle-based sensing require significant advances in technology.

### SUMMARY

Some embodiments provide for a device, comprising: a substrate; and circuitry mounted on the substrate and comprising: a first antenna array comprising a first RF antenna configured to transmit and/or receive RF signals having a first center frequency in a particular frequency range within a range of 150 GHz to 1.5 THz; a plurality of harmonic generation circuits coupled to respective RF antennas in the first antenna array, the plurality of harmonic generation circuits comprising a first harmonic generation circuit coupled to the first RF antenna and configured to obtain a reference RF signal having a second center frequency and generate a harmonic of the reference RF signal, the harmonic having the first center frequency; and a plurality of feedback circuits coupled to the plurality of harmonic generation circuits, respectively, the plurality of feedback circuits comprising a first feedback circuit coupled to the first harmonic generation circuit and configured to regulate a bias state of the first harmonic generation circuit.

Some embodiments, provide for a method for use with a device, the device comprising a substrate and circuitry mounted thereon, the circuitry comprising a first antenna array, a plurality of harmonic generation circuits coupled to respective RF antennas in the first antenna array, and a plurality of feedback circuits coupled to the plurality of harmonic generation circuits, the first antenna array comprising a first RF antenna, the plurality of harmonic generation circuits comprising a first harmonic generation circuit coupled to the first RF antenna, and the plurality of feedback circuits comprising a first feedback circuit coupled to the first harmonic generation circuit, the method comprising: transmitting and/or receiving, using the first RF antenna, RF signals having a first center frequency in a particular frequency range within a range of 150 GHz to 1.5 THz; obtaining, using the first harmonic generation circuit, a reference RF signal having a second center frequency; generating, using the first harmonic generation circuit, a harmonic of the reference RF signal, the harmonic having the first center frequency; and regulating, using the first feedback circuit, a bias state of the first harmonic generation circuit.

Some embodiments provide for a device, comprising: a substrate; signal generation circuitry mounted on the substrate, the signal generation circuitry configured to generate a reference RF signal; and a transmitter mounted on the substrate, the transmitter comprising: a transmit semiconductor die having integrated thereon: a transmit antenna array comprising a plurality of transmit RF antennas configured to transmit first RF signals having a first center frequency in a particular frequency range within a range of 150 GHz to 1.5 THz; a first plurality of frequency multipliers coupled to the plurality of transmit RF antennas, respectively, and configured to generate the first RF signals at least by part by generating a harmonic of the reference RF signal, the harmonic having the first center frequency; and a first plurality of feedback circuits configured to regulate bias currents of the first plurality of frequency multipliers, respectively.

Some embodiments provide for a device, comprising: a substrate; signal generation circuitry mounted on the substrate, the signal generation circuitry configured to generate a reference RF signal; and a receiver mounted on the substrate, the receiver comprising: a first receive semiconductor die having integrated thereon: a receive antenna array comprising a plurality of receive RF antennas configured to receive first RF signals having a first center frequency in a particular frequency range within a range of 150 GHz to 1.5 THz; a first plurality of mixers coupled to the plurality of receive RF antennas, respectively, and configured to generate second RF signals at least in part by mixing the first RF signals with third RF signals that are based on the reference RF signal; and a first plurality of feedback circuits configured to regulate bias currents of the first plurality of mixers, respectively.

Some embodiments provide for a device, comprising: a substrate defining a plane extending in a first direction and a second direction that are orthogonal to one another; signal generation circuitry mounted on the substrate and configured to generate a reference RF signal; and a transmitter mounted on the substrate, the transmitter comprising: a first transmit semiconductor die having integrated thereon: a first transmit antenna array comprising a first plurality of transmit RF antennas configured to transmit first RF signals having a first RF center frequency in a particular frequency range within a range of 150 GHz to 1.5 THz; and first transmit circuitry comprising: a first plurality of RF amplifiers configured to drive the first plurality of transmit RF antennas with first amplified RF signals based on the reference RF signal; and a first plurality of frequency multipliers coupled between the first plurality of RF amplifiers and the first plurality of transmit RF antennas and configured to convert the first amplified RF signals from the first plurality of RF amplifiers to the first RF center frequency to obtain the first RF signals.

Some embodiments provide for a method for use with a device, the device comprising a substrate having signal generation circuitry and a transmitter mounted thereon, the substrate defining a plane extending in a first direction and a second direction that are orthogonal to one another, the transmitter comprising a first transmit semiconductor die having integrated thereon a first transmit antenna array and first transmit circuitry, the first transmit antenna array comprising a first plurality of transmit RF antennas, and the first transmit circuitry comprising a first plurality of RF amplifiers and a first plurality of frequency multipliers coupled between the first plurality of RF amplifiers and the first plurality of transmit RF antennas, the method comprising: generating, using the signal generation circuitry, a reference RF signal; transmitting, using the first plurality of transmit RF antennas, first RF signals having a first RF center frequency in a particular frequency range within a range of 150 GHz to 1.5 THz; driving, using the first plurality of RF amplifiers, the first plurality of transmit RF antennas with first amplified RF signals based on the reference RF signal; and converting, using the first plurality of frequency multipliers, the first amplified RF signals from the first plurality of RF amplifiers to the first RF center frequency to obtain the first RF signals.

Some embodiments provide for a device, comprising: a substrate defining a plane extending in a first direction and a second direction that are orthogonal to one another; signal generation circuitry mounted on the substrate and configured to generate a reference RF signal; a transmitter mounted on the substrate, the transmitter comprising: a first transmit semiconductor die having integrated thereon: a first transmit antenna array comprising a first plurality of transmit RF antennas configured to transmit first RF signals having a first RF center frequency in a particular frequency range within a range of 150 GHz to 1.5 THz; and first transmit circuitry comprising: a first plurality of RF amplifiers configured to drive the first plurality of transmit RF antennas with first amplified RF signals based on the reference RF signal; and a first plurality of frequency multipliers coupled between the first plurality of RF amplifiers and the first plurality of transmit RF antennas and configured to convert the first amplified RF signals from the first plurality of RF amplifiers to the first RF center frequency to obtain the first RF signals; a receiver mounted on the substrate, the receiver comprising: a first receive semiconductor die having integrated thereon: a first receive antenna array comprising a first plurality of receive RF antennas configured to receive second RF signals having the first RF center frequency; and first receive circuitry configured to mix the second RF signals with third RF signals, generated based on the reference RF signal, to obtain fourth RF signals; interface circuitry mounted on the substrate and coupled to the first receive circuitry, the interface circuitry comprising analog-to-digital conversion (ADC) circuitry configured to digitize the fourth RF signals to obtain digitized fourth RF signals; and processing circuitry mounted on the substrate and coupled to the interface circuitry, the processing circuitry configured to determine, based on the digitized fourth RF signals, a distance between the device and a target object that reflected the first RF signals to generate, at least in part, the second RF signals.

Some embodiments provide for a device, comprising: a substrate defining a plane extending in a first direction and a second direction that are substantially orthogonal to one another; and a transmitter mounted on the substrate, the transmitter comprising: a first transmit semiconductor die having integrated thereon: first transmit circuitry configured to generate first RF signals having a first RF center frequency in a particular frequency range within a range of 300 GHz to 1.5 THz, the first transmit circuitry comprising: a first frequency multiplier comprising an input, an output, and a transistor circuit, the transistor circuit comprising: a control terminal configured to obtain a reference RF signal at the input; a first channel terminal configured to generate a first RF signal of the first RF signals at the output having the first RF center frequency; and a second channel terminal, wherein the control terminal and the first channel terminal are configured to control coupling between the first channel terminal and the second channel terminal; and a first transmit antenna array comprising a first plurality of transmit RF antennas configured to transmit the first RF signals.

Some embodiments provide for a method for use with a device, the device comprising a substrate having a transmitter mounted thereon, the substrate defining a plane extending in a first direction and a second direction that are substantially orthogonal to one another, the transmitter comprising a first transmit semiconductor die having integrated thereon a first plurality of transmit RF antennas and first transmit circuitry, the first transmit circuitry comprising a first frequency multiplier comprising an input, an output, and a transistor circuit, and the transistor circuit comprising a control terminal, a first channel terminal, and a second channel terminal, the method comprising: generating, using the first transmit circuitry, first RF signals having a first RF center frequency in a particular frequency range within a range of 300 GHz to 1.5 THz at least in part by: obtaining, using the control terminal of the transistor circuit, a reference RF signal at the input of the first frequency multiplier; generating, using the first channel terminal of the transistor circuit, a first RF signal of the first RF signals having the first RF center frequency at the output of the first frequency multiplier; and controlling, using the control terminal and the first channel terminal, coupling between the first channel terminal and the second channel terminal; and transmitting, using the first plurality of transmit RF antennas, the first RF signals.

Some embodiments provide for a device, comprising: a substrate defining a plane extending in a first direction and a second direction that are substantially orthogonal to one another; signal generation circuitry mounted on the substrate and configured to generate a reference RF signal; a transmitter mounted on the substrate, the transmitter comprising: a first transmit semiconductor die having integrated thereon: first transmit circuitry configured to generate first RF signals having a first RF center frequency in a particular frequency range within a range of 300 GHz to 1.5 THz, the first transmit circuitry comprising: a first frequency multiplier comprising an input, an output, and a transistor circuit comprising: a control terminal configured to obtain a second reference RF signal, generated based on the reference RF signal, at the input; a first channel terminal configured to generate a first RF signal of the first RF signals at the output having the first RF center frequency; and a second channel terminal, wherein the control terminal and the first channel terminal are configured to control coupling between the first channel terminal and the second channel terminal; and a first transmit antenna array comprising a first plurality of transmit RF antennas configured to transmit the first RF signals; a receiver mounted on the substrate, the receiver comprising: a first receive semiconductor die having integrated thereon: a first receive antenna array comprising a first plurality of receive RF antennas configured to receive second RF signals having the first RF center frequency; and first receive circuitry configured to mix the second RF signals with third RF signals, generated based on the reference RF signal, to obtain fourth RF signals; interface circuitry mounted on the substrate and coupled to the first receive circuitry, the interface circuitry comprising analog-to-digital conversion (ADC) circuitry configured to digitize the fourth RF signals to obtain digitized fourth RF signals; and processing circuitry mounted on the substrate and coupled to the interface circuitry, the processing circuitry configured to determine, based on the digitized fourth RF signals, a distance between the device and a target object that reflected the first RF signals to generate, at least in part, the second RF signals.

### BRIEF DESCRIPTION OF THE DRAWINGS

Various aspects and embodiments will be described with reference to the following figures. It should be appreciated that the figures are not necessarily drawn to scale.

FIG. 1 illustrates an example radar device transmitting and receiving RF signals, in accordance with some embodiments of the technology described herein.

FIG. 2 illustrates an example radar device having a transmitter with a transmit antenna array and a receiver with a receive antenna array, in accordance with some embodiments of the technology described herein.

FIG. 3 illustrates RF atmospheric attenuation as a function of the carrier frequency.

FIG. 4 illustrates Terahertz sub-bands suitable to perform ranging, in accordance with some embodiments of the technology described herein.

FIG. 5 illustrates the frequency of an example linear frequency modulated (LFM) signal having a first linear ramp as a function of time, in accordance with some embodiments of the technology described herein.

FIG. 6 illustrates the frequency of an example LFM signal having first and second linear ramps as a function of time, in accordance with some embodiments of the technology described herein.

FIG. 7 illustrates example circuitry including an antenna array, a plurality of harmonic generation circuits, and a plurality of feedback circuits that may be included in a radar device, in accordance with some embodiments of the technology described herein.

FIG. 8 illustrates an example antenna, harmonic generation circuit, and feedback circuit that may be included in the device of FIG. 7, in accordance with some embodiments of the technology described herein.

FIG. 9 illustrates example circuitry including signal generation circuitry and a transmitter that may be included in a radar device, in accordance with some embodiments of the technology described herein.

FIG. 10A illustrates example circuitry including signal generation circuitry and a transmitter having a transmit semiconductor die that may be included in a radar device, in accordance with some embodiments of the technology described herein.

FIG. 10B illustrates example transmit circuitry that may be included in the transmitter of FIG. 10A, in accordance with some embodiments of the technology described herein.

FIG. 11A illustrates an example frequency multiplier including a single-ended transistor circuit that may be included in the transmitters of FIGS. 9 and 10A-10B, in accordance with some embodiments of the technology described herein.

FIG. 11B illustrates an example frequency multiplier including a differential transistor circuit that may be included in the transmitters of FIGS. 9 and 10A-10B, in accordance with some embodiments of the technology described herein.

FIG. 11C illustrates an example frequency multiplier including a differential transistor circuit of opposite conductivity type from FIGS. 11A-11B, which may be included in the transmitters of FIGS. 9 and 10A-10B, in accordance with some embodiments of the technology

FIG. 12A illustrates an example frequency multiplier and feedback circuit that may be included in the transmitters of FIGS. 9 and 10A-10B, in accordance with some embodiments of the technology described herein.

FIG. 12B illustrates an example frequency multiplier and feedback circuit with an alternative reference generator circuit that may be included in the transmitters of FIGS. 9 and 10A-10B, in accordance with some embodiments of the technology described herein.

FIG. 12C illustrates an example frequency multiplier with transformer-based matching circuits and a feedback circuit that may be included in the transmitters of FIGS. 9 and 10A-10B, in accordance with some embodiments of the technology described herein.

FIG. 12D illustrates an example frequency multiplier with inductive and capacitive matching circuits and a feedback circuit that may be included in the transmitters of FIGS. 9 and 10A-10B, in accordance with some embodiments of the technology described herein.

FIG. 13 illustrates direct current (DC) channel current and second harmonic output current vs. bias voltage for an example heterojunction bipolar transistor (HBT) that may be included in the frequency multipliers of FIGS. 11A-12, in accordance with some embodiments of the technology described herein.

FIG. 14 illustrates example second harmonic output current vs. DC channel current for an example HBT transistor that may be included in the frequency multipliers of FIGS. 11A-12, in accordance with some embodiments of the technology described herein.

FIG. 15A illustrates a portion of an example transmitter that may be included in the radar device of FIG. 2, in accordance with some embodiments of the technology described herein.

FIG. 15B illustrates example transmit circuitry that may be included in the transmitter of FIG. 15A, in accordance with some embodiments of the technology described herein.

FIG. 16A illustrates example signal generation circuitry and a receiver that may be included in a radar device, in accordance with some embodiments of the technology described herein.

FIG. 16B illustrates example receive circuitry that may be included in the receiver of FIG. 16A, in accordance with some embodiments of the technology described herein.

FIG. 17 illustrates an example antenna, mixer, amplifier, and feedback circuit that may be included in the in the receiver of FIGS. 16A-16B, in accordance with some embodiments of the technology described herein.

FIG. 18 illustrates another example antenna, mixer, and feedback circuit that may be included in the in the receiver of FIGS. 16A-16B, in accordance with some embodiments of the technology described herein.

FIG. 19 illustrates example interface circuitry that may be included in the radar device of FIG. 2, in accordance with some embodiments of the technology described herein.

FIG. 20 illustrates an example computer system that may be configured to perform at least some processing operations in the radar device of FIG. 2, in accordance with some embodiments of the technology described herein.

### DETAILED DESCRIPTION

### Terahertz-Based Active Sensing

The inventors have developed an active radio-frequency (RF) sensing technology, operating in the Terahertz band, for determining the relative and/or absolute state (e.g., position, velocity, and/or acceleration) of a target object (e.g., a static target object such as a lamp post, a utility pole, a building, or a dynamic target object such as a person, a vehicle, a car, a truck, etc.). The terms “radio-frequency” and “RF” are used herein to refer to electromagnetic signals having frequency content in the 0-3 THz band. The term “Terahertz” is used herein to refer to radio-frequency signals having frequency content in the 300 GHz-3THz band (including the end points).

The RF technology developed by the inventors includes novel RF sensors, signal processing architectures, algorithms, and software. The RF technology developed by the inventors and described herein may be used in a variety of applications. For example, the RF technology may be used in the context of autonomous vehicles, such as autonomous cars, for determining the relative and/or absolute state of one or more target objects in the surrounding environment of the autonomous vehicle (e.g., the relative and/or absolute state of one or more cars, people, or other objects within a threshold distance of the autonomous vehicle). However, the technology described herein may be used in connection with any type of vehicle, including for example land-based vehicles (e.g., cars, trucks, bicycles, motor bicycles and other wheel-based vehicles, and trains and other rail-based vehicles), air-based vehicles (e.g., airplanes, helicopters, drones, etc.), space-based vehicles (e.g., satellites, space vessels, etc.), water-based vehicles (ships, boats, barges, etc.) and any other types of vessels configured to carry a load (e.g., people, animals, plants, equipment, materials, etc.).

RADAR (radio detection and ranging) sensors are active detection sensors that use radio frequency signals to determine the relative and/or absolute state (e.g., position, velocity, and/or acceleration) of a target object. A RADAR sensor has at least one transmitter that emits RF signals toward one or more objects and at least one receiver that detects any RF signals reflected by the object(s). The detected RF signals are processed to determine absolute and/or relative (e.g., to the RADAR sensor) position, velocity, acceleration of the object(s). Unlike optical sensors, RADAR sensors are less susceptible to poor weather conditions and directly detect depth or distance information.

Conventional RADAR sensors used in autonomous vehicles operate in the millimeter wave band (i.e., 30 GHz-300 GHz), or at even lower frequencies. For example, one conventional RADAR sensor operates in the 76 GHZ-81 GHz frequency band. Because of the (relatively long) wavelengths implied by operating in this frequency range, conventional RADAR sensors have limited spatial (e.g., range and angular) resolution. Indeed, conventional RADAR sensors used in the automotive context have range resolutions on the order of several centimeters and horizontal angular resolutions of about 10° to 20°. As a result, while conventional RADAR sensors can identify the presence of some target object, they cannot reliably identify the nature or shape of the target object. For example, such a conventional RADAR sensor may be unable to distinguish a pedestrian from a vehicle or a road signal. An angular resolution of about 1° or less may be necessary to distinguish the types of target objects typically encountered on roads.

Accordingly, the inventors have developed new RF sensing technology for automotive and other autonomous vehicle applications that addresses the above-described shortcomings of conventional sensors. In some embodiments, the sensing technology developed by the inventors improves upon conventional RADAR. For example, because the sensing technology developed by the inventors operates in the Terahertz band, it achieves a spatial resolution that is significantly better than what is possible with conventional RADAR sensors. For example, the sensing technology developed by the inventors achieves range resolutions on the order of 5 mm to 15 mm, and angular resolutions on the order of 0.1° to 5° (e.g., elevation resolution of approximately 0.2°-) 0.9°. As described herein, conventional RADAR sensors can only achieve range resolutions on the order of several centimeters and angular resolutions of about 10° to 20°, which is insufficient for automotive and other applications.

The Terahertz-based active sensing systems described herein may be used in human-operated vehicles (e.g., cars, trucks), autonomous vehicles, as well as in other contexts.

As described herein, operating RADAR at Terahertz frequencies (300 GHz-3THz) is advantageous because the wide bandwidth available for signals in these frequency ranges provides for high range resolution, which is important for some automotive applications. At higher frequencies more bandwidth is available for transmission, which in turn increases the range resolution of the resulting RADAR system.

On the other hand, operating RADAR at Terahertz frequencies presents unique challenges. As one example, atmospheric attenuation at THz frequencies (e.g., at 300 GHz and above) limits the ability of a RADAR system to detect targets at longer distance applications (e.g., at a distance of 300 meters) at a given link budget (e.g., less than 20 Watts), which may be relevant in certain applications such as some automotive applications.

Atmospheric attenuation poses a major challenge. By the time an RF signal travels from a transmitter to a target object, and upon reflection, from the target object to the receiver, the power level of the RF signal is attenuated near or below the receiver's noise floor. Therefore, the receiver's ability distinguish RF signals from noise is significantly impaired. Indeed, Terahertz signals are more susceptible to atmospheric attenuation than millimeter waves or infrared light. Terahertz signals undergo absorption by water vapor and oxygen molecules in the atmosphere. For this reason, atmospheric attenuation degrades with increasing humidity.

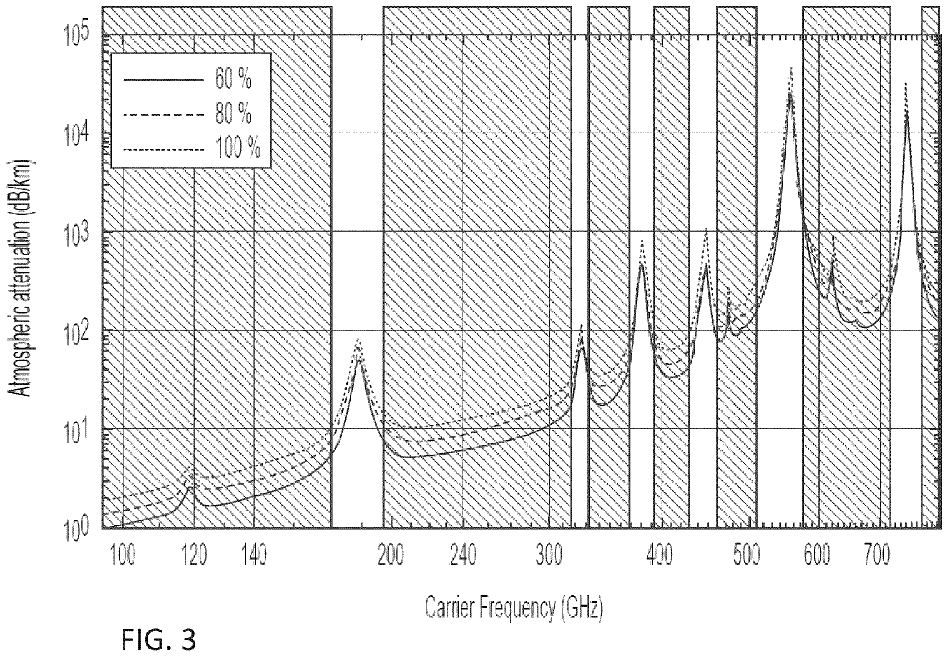

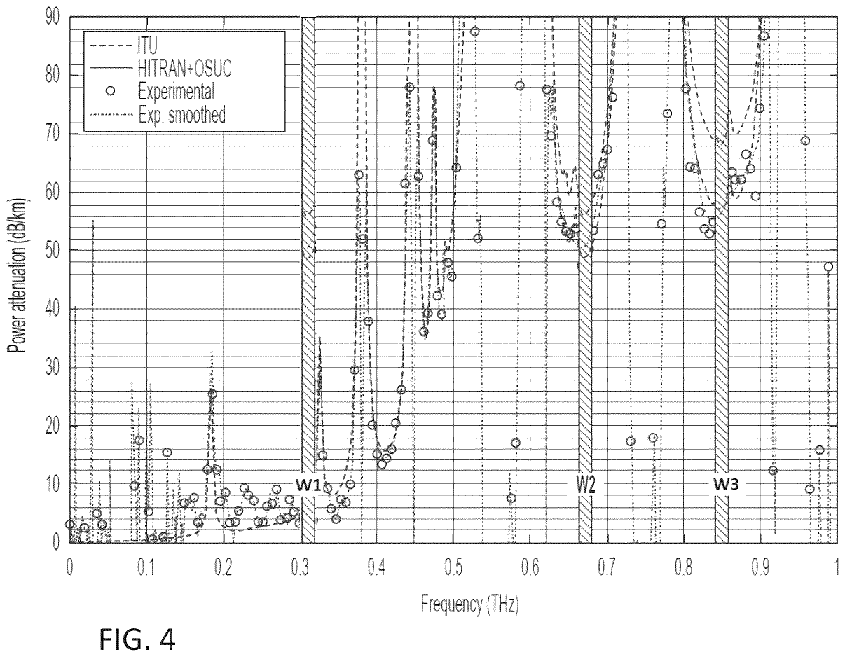

FIG. 3 is a plot illustrating how atmospheric attenuation varies as a function of frequency at a humidity of 60%, 80% and 100%, respectively. At 100 GHz, the atmospheric attenuation is well below 3 dB/km, regardless of the humidity. At 300 GHz, the atmospheric attenuation is between 10 dB/km and 40 dB/km. At 700 GHz, the atmospheric attenuation is above 100 dB/km. FIG. 4 is another plot illustrating the atmospheric attenuation as a function of frequency. Again, attenuation can be quite severe, as high as 1000 dB/km in some bands. Notwithstanding, some frequency bands exhibit local minima. For example, the atmospheric attenuation drops substantially in the frequency bands near 310 GHz, 425 GHZ, 475 GHz, 670 GHz, and 850 GHz. Recognizing this behavior, active sensing systems according to some embodiments are designed to operate in one or more of these frequency bands in which the atmospheric attenuation exhibits local minima.

Another challenge is that switching electronics (e.g., amplifiers and harmonic generators) used in a transmitter and/or receiver of a conventional RADAR device do not operate efficiently at THz frequencies. For example, transistor technologies used in conventional RADAR applications can have maximum switching frequencies as low as 300 GHz. The power efficiency of switching electronics using these transistor technologies declines significantly as the switching frequency approaches the maximum switching frequency, resulting in little of the power input to the switching electronics being output (e.g., in a transmitted RF signal or in a processed received RF signal). As another example, transistor technologies used in conventional RADAR applications are difficult to operate efficiently at THz frequencies because efficient operation may only be achieved over a narrow range of bias states, from which the transistors are susceptible to deviating. For instance, process variation in manufacturing and temperature fluctuation (e.g., from −40 to 85 C in some automotive applications) may push the bias point of the transistors out of a desired bias range, compromising efficiency.

Consequently, operating RADAR at Terahertz frequencies using conventional RADAR techniques requires a significant amount of power to combat both atmospheric attenuation and switching losses in the transmitter and receiver. In some applications (e.g., electric vehicle applications), that much power is not always available when needed for RADAR sensing. Accordingly, the inventors have developed a number of solutions to improve the operating efficiency of a Terahertz RADAR device, facilitating implementation of Terahertz RADAR on a low power budget. One such solution involves novel technology for regulating bias states of harmonic generation circuits in a receiver and/or transmitter of a THz RADAR device. Another solution involves novel technology for coupling frequency multipliers between RF amplifiers and RF antennas, for example, in a transmitter of a THz RADAR device. Yet another solution involves novel technology for implementing frequency multipliers, for example, in a transmitter of a THz RADAR device, using certain transistor configurations (e.g., common-collector or common-drain). A THz RADAR device may implement one, two, or all three of these solutions, as aspects of the technology described herein are not limited in this respect.

### Overview of Terahertz RADAR Device

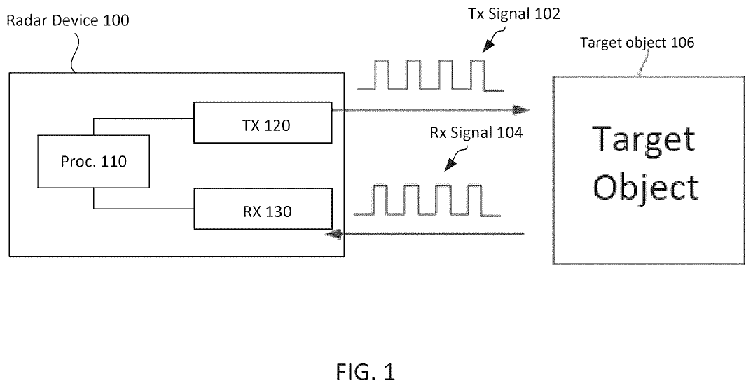

FIG. 1 illustrates an example radar device 100 transmitting and receiving RF signals, in accordance with some embodiments of the technology described herein.

As shown in FIG. 1, the radar device 100 has a transmitter (TX) 120 and a receiver (RX) 130. In some embodiments, TX 120 may include transmit circuitry (analog and/or digital) configured to generate RF transmit signals 102 (e.g., pulses, as shown in FIG. 1) for transmission via a transmit antenna array. In some embodiments, RX 130 may include receive circuitry (analog and/or digital) configured to receive RF signals 104 via a receive antenna array, the RF receive signals generated at least in part by reflection of RF transmit signals from a target object 106.

Also shown in FIG. 1, the radar device 100 includes processing circuitry 110. In some embodiments, processing circuitry 110 may include analog and/or digital circuitry and/or may be implemented, for example, using one or more field programmable gate arrays (FPGA), one or more application-specific integrated circuits (ASICs), one or more processors, and/or one or more microcontrollers. In some embodiments, processing circuitry 110 may be configured to control operation of radar device 100, such as to control timing of RF signal transmission and/or reception, and/or processing circuitry 110 may be configured to process data obtained by radar device 100, such as to generate (e.g., range-cross range) images using received RF signals. According to various embodiments, processing circuitry 110 may be packaged on the same substrate (e.g., printed circuit board) hosting the transmit and/or receive circuitry of radar device 200, and/or processing circuitry 110 may be packaged separately therefrom.

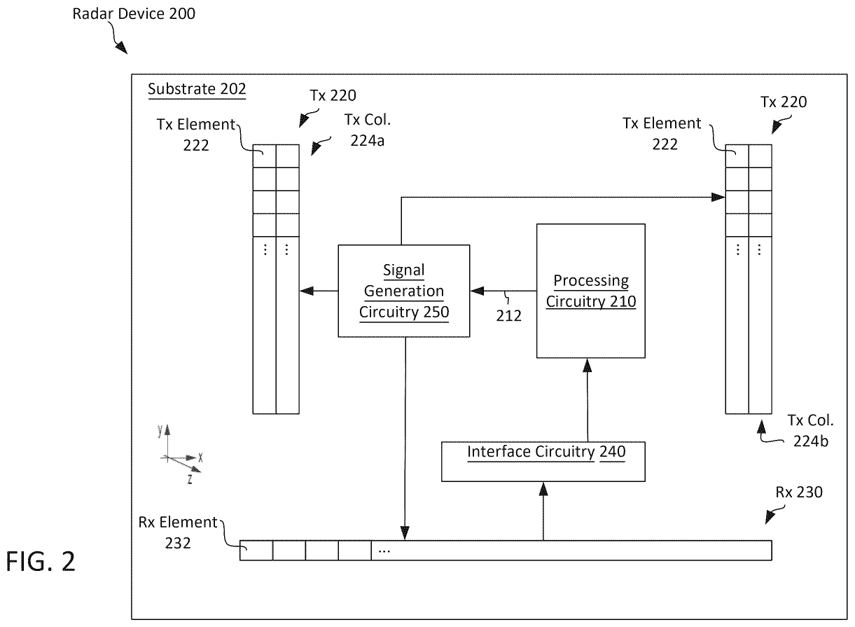

FIG. 2 illustrates an example radar device 200 having a transmitter (TX) 220 with a transmit antenna array and a receiver (RX) 230 with a receive antenna array, in accordance with some embodiments of the technology described herein.

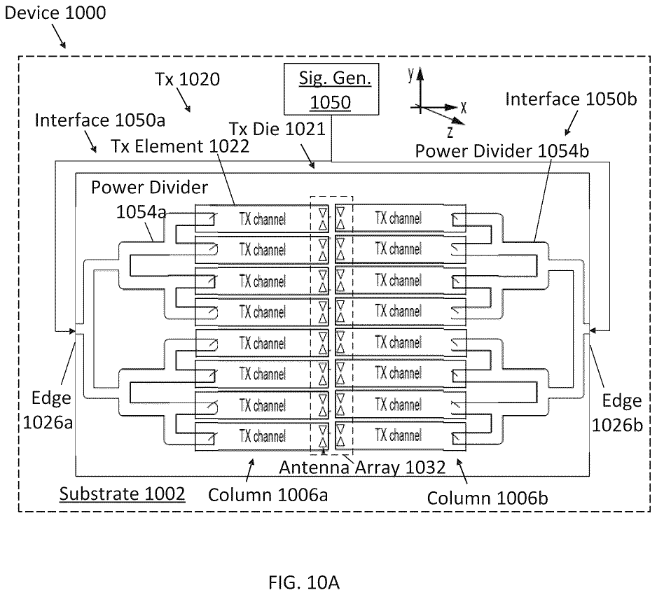

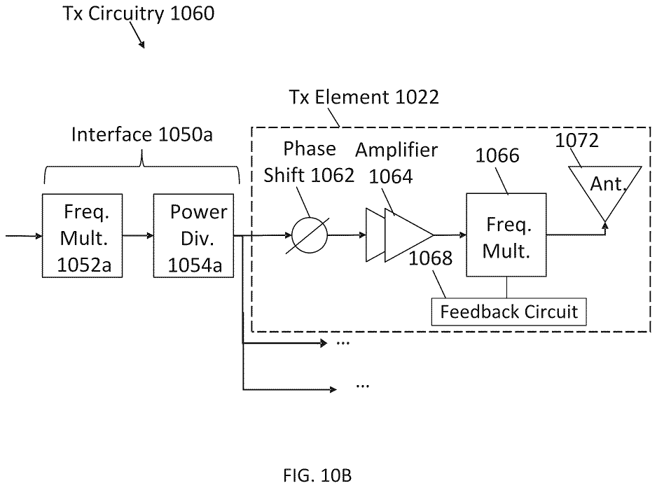

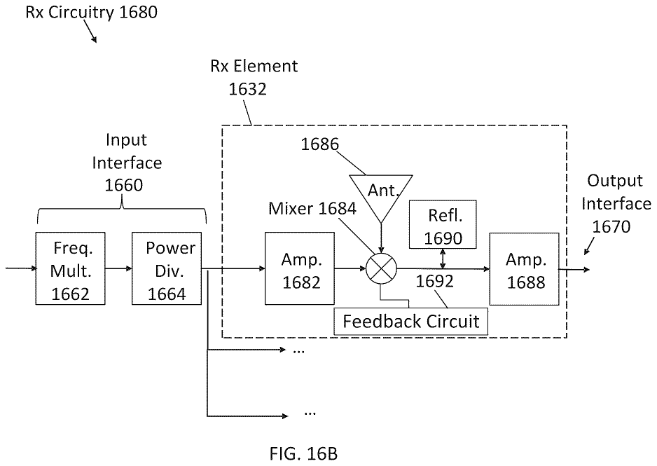

As shown in FIG. 2, radar device 200 includes a substrate 202 having processing circuitry 210, signal generation circuitry 250, TX 220, RX 230, and interface circuitry 240 thereon. In some embodiments, TX 220 and RX 230 may be mounted on substrate 202. For example, TX 220 and RX 230 may include components integrated on one or more semiconductor dies that are mounted (e.g., using wire bonds and/or a ball-grid-array) on substrate 202. For instance, as shown in FIG. 2, TX 220 has a transmit antenna array including transmit antenna elements 222, which may be integrated on a plurality of transmit semiconductor dies (e.g., 1021 in FIG. 10A) mounted on substrate 202. Similarly, as shown in FIG. 2, RX 230 has a receive antenna array including receive antenna elements 232, which may be integrated on a plurality of receive semiconductor dies (e.g., 1631 in FIG. 16A) mounted on substrate 202. In some embodiments, semiconductor dies of TX 220 and/or RX 230 may be mounted directly on substrate 202, and/or may be mounted on one or more interposers, with the interposer(s) mounted directly on substrate 202.

As shown in FIG. 2, TX 220 has a transmit antenna array including transmit antenna elements 222. Each transmit antenna element may be sized to emit signals having frequency content in the frequency band of 150 GHz-3 THz or any frequency band within the 150 GHz-3THz band (e.g., 190-300 GHz, 300-320 GHZ, 307-313 GHZ, 390-450 GHz, 440-480 GHz, 455-495 GHZ, 660-700 GHz, or 820-880 GHz). For example, transmit antenna elements 222 may be sized to emit signals having frequency content in the frequency band of 300-320 GHz or 307-313 GHz. In some embodiments, transmit antenna elements described herein may have a frequency bandwidth (e.g., 3 dB bandwidth) of 1 GHz-4 GHz, 1.5 GHZ, 3 GHZ, 4 GHZ-134 GHz, 4 GHZ-100 GHz, 4 GHZ-60 GHz, 10 GHz-100 GHz, 10 GHz-60 GHz, 10 GHz-30 GHz, 15 GHZ-60 GHz, 10 GHz-30 GHz or 15 GHz-25 GHz. Similarly, RX 230 has receive antenna elements 232 that may be sized to receive signals having frequency content in a frequency band of 150 GHz-3 THz or any sub-band of this frequency band. For example, in some embodiments, receive antenna elements 232 may be sized to receive signals having frequency content in a frequency band of 300-320 GHz or 307-313 GHz. In some embodiments, RX 230 has a frequency bandwidth of 10 GHz-60 GHz, 10 GHZ-30 GHz, 15 GHZ-60 GHz, 10 GHz-30 GHz or 15 GHz-25 GHz.

In some embodiments, TX 220 may be configured to transmit RF signals outside the plane defined by the top surface of substrate 202 (e.g., parallel to the z-axis or at any angle relative to the z-axis other than 90 deg.). For example, a transmit antenna array of TX 220 may be shaped to have a main lobe extending away from the plane defined by the top surface of substrate 202. Similarly, RX 230 may be configured to receive the transmitted signals upon reflection from a target object. For example, a receive antenna array of RX 230 may be shaped to have a main lobe extending away from the plane defined by the top surface of substrate 202.

In some embodiments, TX 220 may have multiple columns of transmit antenna elements extending in one direction and spaced from one another in an orthogonal direction. For example, as shown in FIG. 2, a first pair of columns of transmit antenna elements 222a extends along the y-direction and a second pair of columns of transmit antenna elements 222b extend along the y-direction and are spaced from the first pair of columns along the x-direction.

In some embodiments, interface circuitry 240 may be configured to offload signals from RX 230 and provide the offloaded signals to processing circuitry 210. For example, interface circuitry 240 may include ADC circuitry coupled to RX 230. In some embodiments, ADC circuitry may be implemented using mixed-signal ASICs (e.g., having analog front end (AFE) components of RX 230 and ADC components of interface circuitry 240 coupled to processing circuitry 210). In some embodiments, interface circuitry 240 may be mounted on substrate 202, either directly, or on an interposer. Alternatively or additionally, at least some AFE and/or ADC circuitry may be located in a same integrated circuit package (e.g., on the same die(s)) as processing circuitry 210. For instance, processing circuitry 210 may include an FPGA and/or ASIC having ADC circuitry therein.

In some embodiments, processing circuitry 210 may include digital circuits and/or analog circuits configured to determine the relative and/or absolute state of a target object (e.g., 106 in FIG. 1), such as a distance between device 200 and the target object, based on the reflected signals received from the RX 230 and/or to generate range-cross range images using the reflected signals. Processing circuitry 210 may be mounted on substrate 202, such as shown in FIG. 4 (e.g., on another die such as an FPGA, ASIC, and/or processor), and/or processing circuitry 210 may be integrated on a semiconductor die of RX 230, or, at least in part, on another substrate.

In some embodiments, processing circuitry 210 may be configured to control operation of radar device 200. For example, as shown in FIG. 2, processing circuitry 210 may be configured to provide a control signal 212 to signal generation circuitry 250 that controls signal generation circuitry 250 to generate a reference RF signal for transmission and/or reception using TX 220 and/or RX 230.

While all components are shown mounted on one substrate in FIG. 2, it should be appreciated that, in some embodiments, TX 220 and RX 230 may be mounted on a first substrate and processing circuitry 210 may be mounted on a second substrate that is communicatively coupled to the first substrate. For instance, TX 220 and RX 230 may be mounted on a first side of the first substrate, interface circuitry 240 may be mounted on a second side of the first substrate, and processing circuitry 210 may be mounted on a side of the second substrate that faces the second side of the first substrate. It should be appreciated that other arrangements are possible (e.g., with interface circuitry 240 on the same side of a substrate as TX 220 and RX 230).

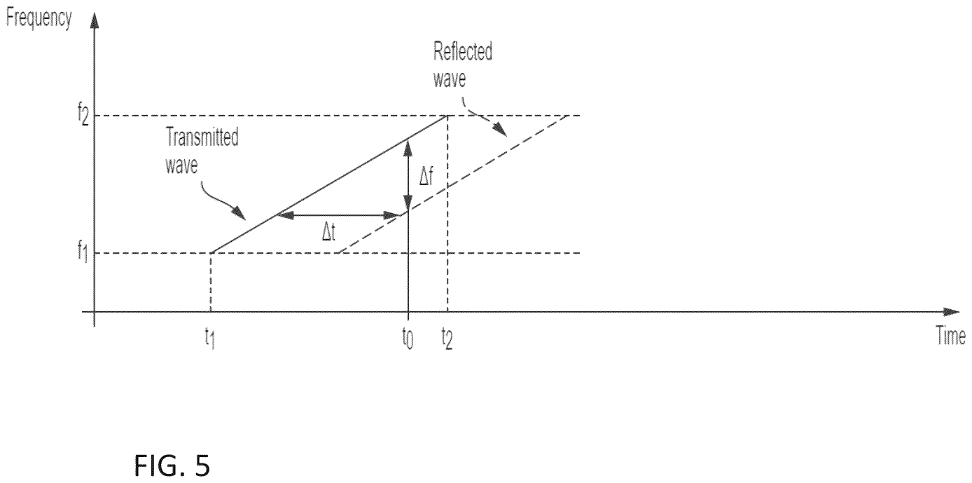

FIG. 5 illustrates the frequency of an example linear frequency modulated (LFM) signal having a first linear ramp as a function of time, in accordance with some embodiments of the technology described herein. In some embodiments, TX 220 (FIG. 2) may be configured to transmit the LFM signal shown in FIG. 5, and RX 230 (FIG. 2) may be configured to receive an RF signal generated, at least in part, by reflection of the LFM signal from a target object (e.g., 106 in FIG. 1).

FIG. 5 illustrates how the frequencies of an example RF signal and the corresponding reflection may vary over time. In the example illustrated in FIG. 5, the transmitted and received RF signals have frequencies that vary according to a linear ramp. For instance, the transmitted RF signal may be generated based on a reference RF signal from signal generation circuitry 250 (FIG. 2), such as a chirp signal. In FIG. 5, the solid line represents the transmitted RF signal, and the dashed line represents the reflected RF signal at the receiver (e.g., RX 230). The frequency of the transmitted RF signal varies from frequency f₁ at time t₁ to frequency f₂ at time t₂. Thus, the bandwidth of the transmitted RF signal is f₂-f₁. In some embodiments, f₁ may be 190 GHz, 300 GHz, 307 GHZ, 390 GHz, 440 GHz, 455 GHz, 650 GHz, 655 GHZ, 660 GHz, 665 GHz, 670 GHz, or 820 GHz, for example. In some embodiments, f₂ may be 300 GHz, 313 GHz, 320 GHZ, 450 GHz, 480 GHz, 495 GHz, 690 GHZ, 685 GHz, 680 GHz, 675 GHz, 670 GHz, or 880 GHZ, for example. Also shown in FIG. 5, the transmitted RF signal has a duration of t₂-t₁. According to various embodiments, t₂-t₁ may be between 500 ms and 1.5 seconds, between 750 ms and 1.25 seconds, or 1 ms.

As shown in FIG. 5, the frequency of the reflected RF signal mirrors the frequency of the transmitted RF signal with a delay Δt. The delay is equal to the time it takes the transmitted RF signal to do a round trip upon hitting a target object. Thus, delay Δt quantifies the distance to the target object. Delay Δt can be obtained by determining the difference between the frequencies (Δf) of the transmitted and received RF signals, respectively, at a certain time to. Because the illustrated chirp signal is linear, delay Δt is given by frequency difference Δf divided by the slope of the linear ramp. In some embodiments, Δf may be 1.5 GHZ, 2.5 GHz, 3 GHZ, 6 GHZ, 10 GHZ, 20 GHz, 30 GHz, 40 GHz, 50 GHz, 60 GHz, 80 GHz, 100 GHz, 120 GHz, or 134 GHz, for example.

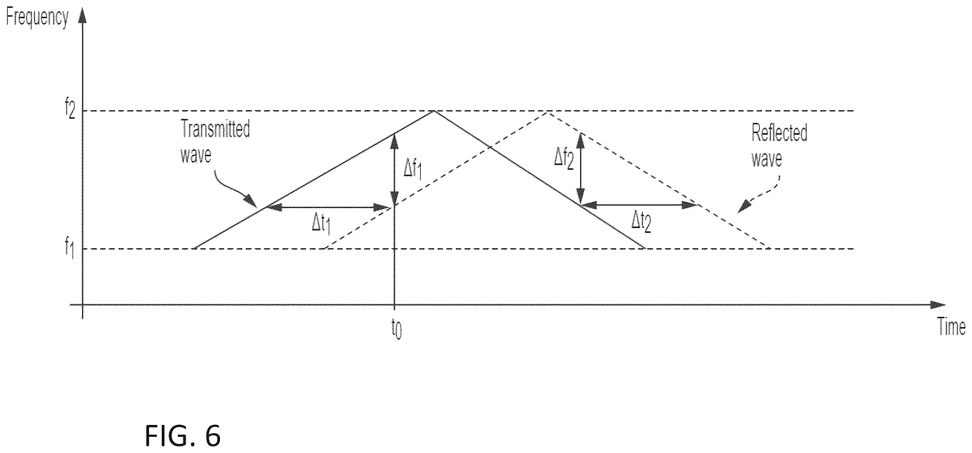

FIG. 6 illustrates the frequency of an example LFM signal having first and second linear ramps as a function of time, in accordance with some embodiments of the technology described herein. In some embodiments, TX 220 (FIG. 2) may be configured to transmit the LFM signal shown in FIG. 6, and RX 230 (FIG. 2) may be configured to receive an RF signal generated, at least in part, by reflection of the LFM signal from a target object (e.g., 106 in FIG. 1). FIG. 6 shows an alternative example RF signal including two linear ramps. In the illustrated example, the first linear ramp is sloped in the direction of increasing frequency (thus forming an up-ramp) and the second linear ramp is sloped in the direction of decreasing frequency (thus forming a down-ramp). The illustrated chirped signal allows a RADAR device to take two distinct measurements, one frequency difference (Δf1, Δf2) for each ramp. The first measurement (At1) quantifies the initial distance to the target object using the first frequency difference (Δf1), the second measurement (At2) quantifies the final distance to the target object using the second frequency difference (Δf2). In some embodiments, the two measurements can be used to quantify the velocity of the target object. In some embodiments, one side of a one- or two-ramp signal may be used to quantify the velocity of a target object using doppler phase shift processing. While no duration is labeled in FIG. 6, in some embodiments, the duration of a two-ramp signal may be twice that of a single linear ramp, though in other embodiments, the duration may be the same as that of a single linear ramp (e.g., having a pair of ramps that are each half as long in time as in the single ramp signal).

### Harmonic Generator Bias Regulation

As described above, the inventors have developed solutions to improve the operating efficiency of Terahertz RADAR devices. The inventors have recognized that transistor technologies used in previous harmonic generators are difficult to operate efficiently at THz frequencies because efficient operation may only be achieved over a narrow range of bias states, from which the transistors are susceptible to deviation (e.g., due to process variation and/or temperature fluctuation).

As described herein, harmonic generators include active, non-linear circuitry configured to, in response to obtaining an input signal having a center frequency, generate an output signal having a center frequency that is a harmonic of the center frequency of the input signal. One example of a harmonic generator is a frequency multiplier, which may be configured to convert a reference RF signal, input to the frequency multiplier at an input center frequency, to an RF signal having an output center frequency that is a harmonic of the input center frequency.

Another example of a harmonic generator is a mixer, which may be configured to mix a reference RF signal, input to a first port of the mixer and having a first input center frequency, with an RF signal, obtained at a second port of the mixer and having a second input center frequency that is a harmonic of the first input center frequency, such that the reference RF signal is converted to the second input center frequency and mixed with the RF signal to output an intermediate frequency (IF) and/or baseband signal.

The inventors have recognized that a harmonic generator may be sensitive to input power level (e.g., of a reference RF signal from which a harmonic is generated), such that an undesirable bias state results in input power at only some input power levels being efficiently converted to a harmonic frequency while other power levels may be lost, compromising efficiency. While some transistor technologies (e.g., bipolar transistors) may exhibit less sensitivity to input power level when biased with a bias current (e.g., as opposed to a bias voltage), deviation from a desired range of bias currents may result in lower efficiency across all input power levels.

Accordingly, some aspects of the present disclosure relate to regulating a bias state of a harmonic generation circuit (e.g., in a receiver and/or transmitter), which facilitates efficient operation of the harmonic generation circuit. For example, a harmonic generation circuit may be configured to generate a harmonic, having a first (e.g., THz) center frequency, of a reference RF signal having a second center frequency. For instance, the reference RF signal may have a second center frequency of 155 GHz and the harmonic generation circuit may be configured to generate a second harmonic of the reference RF signal, the second harmonic having a first center frequency of 310 GHz. Thus, it may be advantageous to operate the harmonic generation circuit in a bias state (e.g., with a bias voltage and/or current) that provides efficient conversion of RF energy from the second center frequency to the first center frequency. In some embodiments, a feedback circuit may be coupled to the harmonic generation circuit and configured to regulate a bias state of the harmonic generation circuit. For example, regulating the bias state of the harmonic generation circuit may counteract deviations in the bias state due to process variation and/or temperature fluctuations that would otherwise push the harmonic generation circuit into a less efficient bias state.

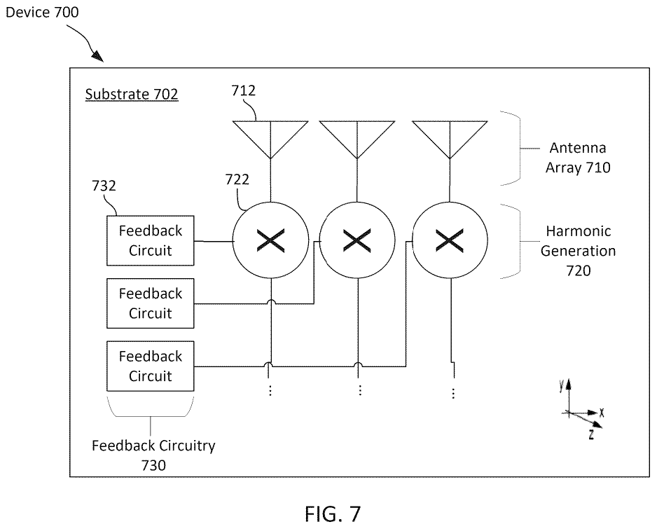

Some embodiments provide for a RADAR device (e.g., 700 in FIG. 7), comprising: (A) a substrate (e.g., 702); and (B) circuitry mounted on the substrate and comprising: a first antenna array (e.g., 710) comprising a first RF antenna (e.g., 712) configured to transmit and/or receive RF signals having a first center frequency in a particular frequency range within a range of 150 GHz to 1.5 THz; a plurality of harmonic generation circuits (e.g., 720) coupled to respective RF antennas in the first antenna array, the plurality of harmonic generation circuits comprising a first harmonic generation circuit (e.g., 722) coupled to the first RF antenna and configured to obtain a reference RF signal having a second center frequency and generate a harmonic of the reference RF signal, the harmonic having the first center frequency; and a plurality of feedback circuits (e.g., 730) coupled to the plurality of harmonic generation circuits, respectively, the plurality of feedback circuits comprising a first feedback circuit (e.g., 732) coupled to the first harmonic generation circuit and configured to regulate a bias state of the first harmonic generation circuit.

In some embodiments, the circuitry comprises a first semiconductor die (e . . . g, 1021, 1631) having integrated thereon the first antenna array, the plurality of harmonic generation circuits, and the plurality of feedback circuits. For example, the first semiconductor die may be configured as a transmit semiconductor die and/or as a receive semiconductor die, which may be mounted on the substrate. For instance, where the first semiconductor die is configured as a transmit semiconductor die, the first harmonic generation circuit may include a frequency multiplier, and/or where the first semiconductor die is configured as a receive semiconductor die, the first harmonic generation circuit may include a mixer.

In some embodiments, the RADAR device (e.g., 1000, 1600) further comprises: signal generation circuitry (e.g., 1150, 1650) mounted on the substrate (e.g., 1002, 1602) and configured to generate a first signal, wherein the circuitry further comprises: a second semiconductor die (e.g., 1021, 1631) having integrated thereon: a second antenna array (e.g., 710) comprising a second RF antenna (e.g., 712) configured to transmit and/or receive RF signals having the first center frequency; a second plurality of harmonic generation circuits (e.g., 720) coupled to respective RF antennas in the second antenna array, the plurality of harmonic generation circuits comprising a second harmonic generation circuit (e.g., 722) coupled to the second RF antenna and configured to obtain a second reference RF signal having the second center frequency and generate a harmonic of the second reference RF signal, the harmonic having the first center frequency; and a second plurality of feedback circuits (e.g., 730) coupled to the second plurality of harmonic generation circuits, respectively, the second plurality of feedback circuits comprising a second feedback circuit (e.g., 732) coupled to the second harmonic generation circuit and configured to regulate a bias state of the second harmonic generation circuit, and wherein the reference RF signal and the second reference RF signal are based on the first signal.

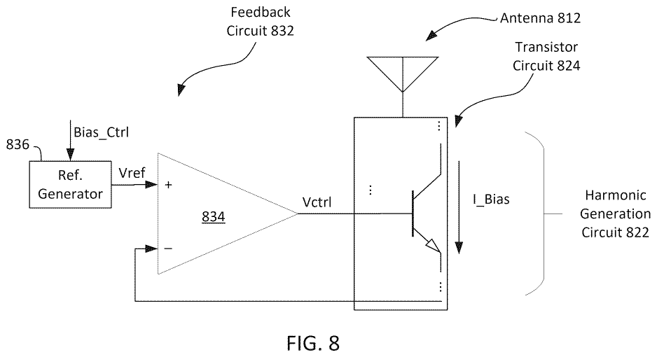

In some embodiments, the first feedback circuit (e.g., 832) is configured to regulate a bias current (e.g., I_Bias in FIG. 8) of the first harmonic generation circuit (e.g., 822). In some embodiments, the first harmonic generation circuit (e.g., 822) comprises a transistor circuit (e.g., 824) comprising a channel and a control terminal, and the first feedback circuit (e.g., 832) is configured to regulate a channel current in the channel by controlling the control terminal. For example, the bias current may include the channel current (e.g., alone or in combination with channel currents flowing in other transistor circuits of the first harmonic generation circuit).

In some embodiments, the transistor circuit (e.g., 824) further comprises channel terminals coupled to the channel, and the first feedback circuit (e.g., 832) comprises an input (e.g., inverting input of amplifier 834) coupled to a channel terminal of the channel terminals and an output (e.g., providing Vctrl in FIG. 8) coupled to the control terminal. In some embodiments, the first feedback circuit (e.g., 832) comprises an amplifier (e.g., 834) having a first input (e.g., inverting input in FIG. 8) coupled to the channel terminal of the transistor circuit (e.g., 824), a second input (e.g., non-inverting input in FIG. 8) configured to receive a reference voltage (e.g., Vref in FIG. 8), and an output (e.g., providing Vctrl in FIG. 8) coupled to the control terminal of the transistor circuit.

In some embodiments, each of the plurality of feedback circuits (e.g., 832) is configured to obtain a respective reference voltage and/or current (e.g., Vref in FIG. 8) and regulate a respective bias state of a respective harmonic generation circuit (e.g., 822) of the plurality of harmonic generation circuits based on the respective reference voltage and/or current. For example, a reference voltage may be input to an amplifier (e.g., 834) for differential voltage feedback, and/or a reference current may be converted to a voltage and input to an amplifier. In some embodiments a reference voltage and a reference current may be used, such as to regulate a bias voltage and a bias current of a harmonic generation circuit.

In some embodiments, each of the plurality of feedback circuits (e.g., 832) is further configured to receive a respective bias control signal (e.g., Bias_Ctrl in FIG. 8) and generate the respective reference voltage and/or current (e.g., Vref) based on the respective bias control signal.

In some embodiments, the harmonic having the first center frequency is a second harmonic of the reference RF signal having the second center frequency. For example, the first harmonic generation circuit may include a frequency doubler and/or a second harmonic mixer. For instance, the reference RF signal obtained by the first harmonic generation circuit may have a center frequency of 155 GHz and the harmonic generated by the first harmonic generation circuit may have a center frequency of 310 GHz.

In some embodiments, the plurality of harmonic generation circuits comprise a plurality of frequency multipliers (e.g., 1066), the first harmonic generation circuit comprises a first frequency multiplier of the plurality of frequency multipliers, the first frequency multiplier is configured to generate an output signal having the first center frequency, and the first RF antenna (e.g., 1072) is configured to transmit a first RF signal based on the output signal. In some embodiments, the plurality of harmonic generation circuits comprise a plurality of mixers (e.g., 1684), the first harmonic generation circuit comprises a first mixer of the plurality of mixers, and the first mixer is configured to mix a second RF signal, obtained using the first RF antenna (e.g., 1686), with the reference RF signal to output a first mixed signal. In some embodiments, the first mixed signal has a third center frequency indicative of a distance between the RADAR device (e.g., 100 in FIG. 1) and a target object (e.g., 106 in FIG. 1) from which the second RF signal was received by the first RF antenna.

In some embodiments, the first center frequency is between 300 GHz and 320 GHz, such as 310 GHz. In some embodiments, the RF signals have a bandwidth of at least 2 GHz, at least 3 GHz, or at least 6 GHz. For example, the RF signals may include linear frequency modulated (LFM) pulses (e.g., FIGS. 5-6).

Some embodiments provide for a method for use with a RADAR device (e.g., 700 in FIG. 7), the RADAR device comprising a substrate (e.g., 702) and circuitry mounted thereon, the circuitry comprising a first antenna array (e.g., 710), a plurality of harmonic generation circuits (e.g., 720) coupled to respective RF antennas in the first antenna array, and a plurality of feedback circuits (e.g., 730) coupled to the plurality of harmonic generation circuits, the first antenna array comprising a first RF antenna (e.g., 712), the plurality of harmonic generation circuits comprising a first harmonic generation circuit (e.g., 722) coupled to the first RF antenna, and the plurality of feedback circuits comprising a first feedback circuit (e.g., 732) coupled to the first harmonic generation circuit, the method comprising: (A) transmitting and/or receiving, using the first RF antenna, RF signals having a first center frequency in a particular frequency range within a range of 150 GHz to 1.5 THz; (B) obtaining, using the first harmonic generation circuit, a reference RF signal having a second center frequency; (C) generating, using the first harmonic generation circuit, a harmonic of the reference RF signal, the harmonic having the first center frequency; and (D) regulating, using the first feedback circuit, a bias state of the first harmonic generation circuit.

In some embodiments, the first harmonic generation circuit (e.g., 822) comprises a transistor circuit (e.g., 824) comprising a channel and a control terminal, and wherein regulating the bias state of the first harmonic generation circuit comprises regulating, using the first feedback circuit, a channel current in the channel by controlling the control terminal.

In some embodiments, the method further comprises, using each of the plurality of feedback circuits (e.g., 832): obtaining a respective reference voltage and/or current (e.g., Vref); and regulating a respective bias state of a respective harmonic generation circuit (e.g. 822) of the plurality of harmonic generation circuits based on the respective reference voltage and/or current.

In some embodiments, the plurality of harmonic generation circuits comprise a plurality of frequency multipliers (e.g., 1066); the first harmonic generation circuit comprises a first frequency multiplier of the plurality of frequency multipliers; the method further comprises generating, using the first frequency multiplier, an output signal having the first center frequency; and transmitting and/or receiving the RF signals comprises transmitting, using the first RF antenna (e.g., 1072), an RF signal based on the output signal.

In some embodiments, the plurality of harmonic generation circuits comprise a plurality of mixers (e.g., 1684); the first harmonic generation circuit comprises a first mixer of the plurality of mixers; and the method further comprises mixing, using the first mixer, an RF signal, obtained using the first RF antenna (e.g., 1686), with the reference RF signal to output a first mixed signal.

Some embodiments provide for a RADAR device (e.g., 1000), comprising: (A) a substrate (e.g., 1002); (B) signal generation circuitry (e.g., 1150) mounted on the substrate, the signal generation circuitry configured to generate a reference RF signal; and (C) a transmitter (e.g., 1020) mounted on the substrate, the transmitter comprising: a transmit semiconductor die (e.g., 1021) having integrated thereon: a transmit antenna array (e.g., 1032) comprising a plurality of transmit RF antennas (e.g., 1072) configured to transmit first RF signals having a first center frequency in a particular frequency range within a range of 150 GHz to 1.5 THz; a first plurality of frequency multipliers (e.g., 1066) coupled to the plurality of transmit RF antennas, respectively, and configured to generate the first RF signals at least by part by generating a harmonic of the reference RF signal, the harmonic having the first center frequency; and a first plurality of feedback circuits (e.g., 1068) configured to regulate bias currents of the first plurality of frequency multipliers, respectively.

Some embodiments provide for a RADAR device (e.g., 1600), comprising: (A) a substrate (e.g., 1602); (B) signal generation circuitry (e.g., 1650) mounted on the substrate, the signal generation circuitry configured to generate a reference RF signal; and (C) a receiver (e.g., 1630) mounted on the substrate, the receiver comprising: a first receive semiconductor die (e.g., 1631) having integrated thereon: a receive antenna array (e.g., 1639) comprising a plurality of receive RF antennas (e.g., 1686) configured to receive first RF signals having a first center frequency in a particular frequency range within a range of 150 GHz to 1.5 THz; a first plurality of mixers (e.g., 1684) coupled to the plurality of receive RF antennas, respectively, and configured to generate second RF signals at least in part by mixing the first RF signals with third RF signals that are based on the reference RF signal; and a first plurality of feedback circuits (e.g., 1692) configured to regulate bias currents of the first plurality of mixers, respectively.

FIG. 7 illustrates example circuitry including an antenna array 710, a plurality of harmonic generation circuits 720, and a plurality of feedback circuits 730 that may be included in a RADAR device, e.g., 700, in accordance with some embodiments of the technology described herein.

In some embodiments, device 700 may be configured as described herein for device 200, including in connection with FIG. 2. For example, as shown in FIG. 7, device 700 includes a substrate 702 having antenna array 710, harmonic generation circuits 720, and feedback circuits 730 mounted thereon. For example, antenna array 710, harmonic generation circuits 720, and feedback circuits 730 may be included in a transmitter (e.g., 220 in FIG. 2) and/or a receiver (e.g., 230 in FIG. 2). For instance, as described further herein, harmonic generation circuits 720 may be configured as frequency multipliers, e.g., within a transmitter, configured to generate an RF signal for transmission via a transmit RF antenna, and/or as mixers, e.g., within a receiver, configured to mix an RF signal received via a receive RF antenna.

In some embodiments, antenna array 710 may be configured to transmit and/or receive RF signals having a first center frequency in a particular frequency range within a range of 150 GHz to 1.5 THz. For example, antenna array 710 may be configured as a transmit antenna array configured to transmit RF signals, such as described further herein including in connection with FIGS. 10A-10B, and/or as a receive antenna array, such as described fruther herein including in connection with FIGS. 16A-16B. As shown in FIG. 7, antenna array 710 includes first RF antenna 712.

In some embodiments, harmonic generation circuits 720 may be configured to obtain a reference RF signal having a second center frequency and generate a harmonic of the reference RF signal, the harmonic having the first center frequency of the RF signals transmitted and/or received via antenna array 710. For example, harmonic generation circuits 720 may be configured to obtain the reference RF signal via signal generation circuitry (e.g., 250 in FIG. 2) and generate the harmonic using, e.g., non-linear active circuitry operation. In the illustrated embodiment of FIG. 7, harmonic generation circuits 720 are coupled to respective RF antennas in antenna array 710 and include a first harmonic generation circuit 722 coupled to first RF antenna 712.

In some embodiments, harmonic generation circuits 720 may include frequency multipliers configured to generate output signals having the first center frequency, and RF antenna 712 may be configured to transmit first RF signals based on the output signals, such as where harmonic generation circuits 720 and antenna array 710 are included in a transmitter (e.g., 1020 in FIG. 10A). Alternatively or additionally, in some embodiments, harmonic generation circuits 720 may include mixers configured to mix second RF signals, obtained using antenna array 710, with the reference RF signal to output first mixed signals, such as where harmonic generation circuits 720 and antenna array 710 are included in a receiver (e.g., 1630 in FIG. 16A).

For example, the first mixed signals may have a third center frequency indicative of a distance between RADAR device 900 and a target object (e.g., 106 in FIG. 1) from which the second RF signals were received by antenna array 710.

In some embodiments, harmonic generation circuits 720 may be configured to generate the harmonic, having the first center frequency, as a second harmonic of the reference RF signal having the second center frequency. For example, harmonic generation circuits 720 may include frequency doublers and/or second harmonic mixers. For instance, the reference RF signal obtained by harmonic generation circuits 720 may have a center frequency in a range from 150 GHz to 160 GHz, such as 155 GHz, and the harmonic generated by the first harmonic generation circuit may have a center frequency in a range from 300 GHz to 320 GHz, such as 310 GHz.

In some embodiments, feedback circuits 730 may be configured to regulate bias states of harmonic generation circuits 720. For example, feedback circuits 730 may be configured to regulate bias voltages and/or bias currents within harmonic generation circuits 720, such as to maintain the bias voltages and/or bias currents within a voltage and/or current range. For instance, feedback circuits 730 may be configured to regulate bias voltages applied to control terminals of transistor circuits of harmonic generation circuits 730 and/or bias currents applied to channels of transistor circuits of harmonic generation circuits 730. In some embodiments, regulating bias states of harmonic generation circuits 720 using feedback circuits 730 keeps harmonic generation circuits 730 operating in efficient bias states despite process variation and/or temperature fluctuations that would otherwise push the bias states of harmonic generation circuits 730 out of such bias states. In the illustrated embodiment of FIG. 7, feedback circuits 730 are coupled to respective harmonic generation circuits 720 and include a first feedback circuit 732 coupled to first harmonic generation circuit 722.

In some embodiments, antenna array 710, harmonic generation circuits 720, and feedback circuits 730 may be integrated on a semiconductor die. For example, the semiconductor die may be configured as a transmit semiconductor die and/or as a receive semiconductor die, which may be mounted on substrate 702. For instance, where the semiconductor die is configured as a transmit semiconductor die, harmonic generation circuits 720 may include frequency multipliers, and/or where the semiconductor die is configured as a receive semiconductor die, harmonic generation circuits 720 may include mixers. In some embodiments, where harmonic generation circuits 720 are implemented on a semiconductor die, harmonic generation circuits 720 may be configured to obtain the reference RF signal via traces of substrate 702 (e.g., with signal generation circuitry mounted thereon).

In some embodiments, operating RADAR device 700 may include transmitting and/or receiving, using first RF antenna 712, a first RF signal having a first center frequency in a particular frequency range within a range of 150 GHz to 1.5 THz. For example, the first RF signal may be a transmitted RF signal and/or a received RF signal, such as with the first center frequency between 300 GHz and 320 GHz, such as 310 GHz.

In some embodiments, operating RADAR device 700 may further include obtaining, using harmonic generation circuit 722, a reference RF signal having a second center frequency and generating, using first harmonic generation circuit 722, a harmonic of the reference RF signal, the harmonic having the first center frequency. For example, the harmonic of the reference RF signal may have the first center frequency for transmission and/or as received by first RF antenna 712.

In some embodiments, operating RADAR device 700 may further include regulating, using first feedback circuit 732, a bias state of first harmonic generation circuit 722. For example, regulating the bias state of first harmonic generation circuit 722 may occur, at least in part, during generating the harmonic of the reference RF signal, such as to maintain the bias state for efficient conversion of RF energy from the second center frequency of the reference RF signal to the harmonic.

While not shown in FIG. 7, it should be appreciated that device 700 may alternatively or additionally include processing circuitry (e.g., 210 in FIG. 2) and/or interface circuitry (e.g., 240) mounted on substrate 702. For example, the processing circuitry may be configured to determine, based on RF signals processed using the receiver, a distance between device 700 and a target object (e.g., 106 in FIG. 1), such as described herein including in connection with FIGS. 1-6.

FIG. 8 illustrates an example antenna 812, harmonic generation circuit 822, and feedback circuit 832 that may be included in device 700, in accordance with some embodiments of the technology described herein.

In some embodiments, antenna 812, harmonic generation circuit 822, and feedback circuit 832 may be configured as described herein for first RF antenna 712, first harmonic generation circuit 722, and first feedback circuit 732, respectively, including in connection with FIG. 7. For example, as shown in FIG. 8, harmonic generation circuit 822 is coupled to antenna 812 and feedback circuit 832 is coupled to harmonic generation circuit 822.

In some embodiments, feedback circuit 832 may be configured to regulate a bias current of harmonic generation circuit 822. For example, as shown in FIG. 8, harmonic generation circuit 822 includes a transistor circuit 824, and feedback circuit 832 may be configured to regulate a channel current in a channel of transistor circuit 824 by controlling a control terminal of transistor circuit 824. For instance, as shown in FIG. 8, transistor circuit 824 is shown including a transistor with a bias current I_Bias flowing in its channel and with a control terminal coupled to feedback circuit 832. In the illustrated example of FIG. 8, bias current I_Bias is the channel current flowing through the transistor of transistor circuit 824, but in other examples (e.g., a transistor circuit including multiple transistors coupled in parallel) the bias current may include current in addition to that shown flowing through the transistor in FIG. 8.

In some embodiments, feedback circuit 832 may include an input (e.g., inverting input of amplifier 834) coupled to a channel terminal of transistor circuit 824 and an output (e.g., providing Vctrl in FIG. 8) coupled to the control terminal of transistor circuit 824. For example, as shown in FIG. 8, feedback circuit includes an amplifier 834 with a first, inverting input coupled to the channel terminal of the transistor of transistor circuit 824, a second, non-inverting input configured to receive a reference voltage Vref, and an output coupled to the control terminal of transistor circuit 824. For instance, amplifier 834 may be configured to provide a control voltage Vctrl to the control terminal of the transistor that adjusts the bias current I_Bias conducted through the channel of the transistor until the voltage obtained at the inverting input of amplifier 834 via the channel terminal of the transistor matches the reference voltage Vref. While not shown in FIG. 8, in some embodiments, the inverting input of amplifier 834 may be coupled to a resistor that is coupled to the channel of the transistor such as to convert the bias current I_Bias to a sense voltage that provides feedback to the inverting input.

In some embodiments, feedback circuit 832 may be configured to obtain a reference voltage and/or current and regulate a bias state of harmonic generation circuit 822 based on the reference voltage and/or current. For example, as shown in FIG. 8, feedback circuit 832 includes a reference generator circuit 836 configured to provide reference voltage Vref to amplifier 834. Alternatively or additionally, a reference current may be converted to a voltage and input to amplifier 834. In some embodiments a reference voltage and a reference current may be used, such as to regulate a bias voltage and a bias current of (e.g., a transistor of) harmonic generation circuit 822.

In some embodiments, feedback circuit 832 may be further configured to receive a bias control signal (e.g., Bias_Ctrl in FIG. 8) and generate a reference voltage and/or current (e.g., Vref) based on the bias control signal. For example, as shown in FIG. 8, reference generator circuit 836 is configured to receive a bias control signal Bias_Ctrl. For instance, reference generator circuit 836 may be configured to set a voltage level of reference voltage Vref based on (e.g., an analog voltage and/or digital value of) bias control signal Bias_Ctrl. In some embodiments, receiving a bias control signal at a feedback circuit facilitates fine-tuning the bias state of the harmonic generation circuit after assembly is complete.

While not shown in FIGS. 7-8, it should be appreciated that each feedback circuit of feedback circuits 732 may be configured to obtain a respective reference voltage and/or current and regulate a bias state of a respective harmonic generation circuit of harmonic generation circuits 720 based on the respective reference voltage and/or current, such as described herein for feedback circuit 832. For instance, a respective reference voltage and/or current may be obtained by each feedback circuit 832, such as by each feedback circuit 832 receiving a respective bias control signal and generating the respective reference voltage and/or current based on the respective bias control signal. In some embodiments, providing for a respective reference voltage and/or current at each feedback circuit 832 facilitates regulating each harmonic generation circuit to operate in an efficient bias state despite variation in characteristics among the harmonic generation circuits.

### Amplifier-Frequency Multiplier Transmitter Configuration

As described above, the inventors have developed solutions to improve the operating efficiency of a Terahertz RADAR device. The inventors have recognized that switching electronics (e.g., amplifiers) in a transmitter and/or receiver of a conventional RADAR device do not operate efficiently at THz frequencies, at least in part because efficiency declines significantly as the frequency of operation approaches the maximum switching frequency of the transistor technology. One might couple an amplifier between a frequency multiplier and an RF antenna, which provides good linearity for high integrity transmission of modulated signals and efficient coupling of power from the amplifier into the RF antenna. On the other hand, the amplifier provides little to no power gain when operated at THz frequencies at which the amplified signals are to be transmitted as a result of the amplifier being operated at a frequency close to the maximum switching frequency of the amplifier's underlying transistor technology.

Accordingly, some aspects of the present disclosure relate to coupling frequency multipliers between RF amplifiers and transmit RF antennas in a transmit antenna array, which facilitates efficient amplification and frequency multiplication of RF signals transmitted using the transmit antenna array. For example, the transmit RF antennas of the transmit antenna array may be configured to transmit RF signals having an RF (e.g., THz) center frequency, and frequency multipliers may be coupled between the RF amplifiers and the transmit RF antennas to convert amplified RF signals from the RF amplifiers to the RF center frequency to obtain the RF signals transmitted by the transmit RF antennas. Thus, the RF amplifiers may be operated at a lower frequency than (e.g., one-half of) the RF center frequency of the RF signals to be transmitted, such that high power gain is obtained from the RF amplifiers. Such configurations may advantageously trade off some of the power gain in losses within the frequency multiplier (e.g., by not directly coupling the amplified signal to the RF antenna for transmission) and/or trade off some linearity of modulation of the transmitted RF signals in exchange for overall higher power efficiency. For instance, linearity of modulation may not be as important in some applications (e.g., RADAR) as in others (e.g., data communication).

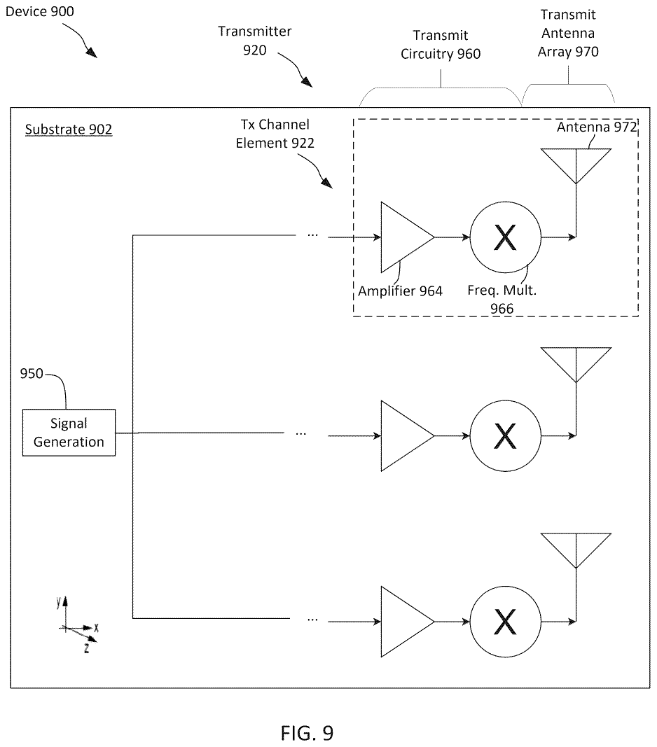

Some embodiments provide for a RADAR device (e.g., 900 in FIG. 9), comprising: (A) a substrate (e.g., 902) defining a plane extending in a first direction (e.g., the y-direction in FIG. 9) and a second direction (e.g., the x-direction in FIG. 9) that are orthogonal to one another; (B) signal generation circuitry (e.g., 950) mounted on the substrate and configured to generate a reference RF signal; and (C) a transmitter (e.g., 920) mounted on the substrate, the transmitter comprising: a first transmit semiconductor die (e.g., 1021 in FIG. 10A) having integrated thereon: a first transmit antenna array (e.g., 970) comprising a first plurality of transmit RF antennas (e.g., 972) configured to transmit first RF signals having a first RF center frequency in a particular frequency range within a range of 150 GHz to 1.5 THz; and first transmit circuitry (e.g., 960) comprising: a first plurality of RF amplifiers (e.g., 964) configured to drive the first plurality of transmit RF antennas with first amplified RF signals based on the reference RF signal; and a first plurality of frequency multipliers (e.g., 966) coupled between the first plurality of RF amplifiers and the first plurality of transmit RF antennas and configured to convert the first amplified RF signals from the first plurality of RF amplifiers to the first RF center frequency to obtain the first RF signals.

In some embodiments, the first plurality of frequency multipliers are coupled directly to the first plurality of transmit RF antennas to provide the first RF signals to the first plurality of transmit RF antennas (e.g., FIG. 9). For example, no active circuitry (e.g., amplifiers) may be coupled between the first plurality of frequency multipliers and the first plurality of transmit RF antennas. For instance, only conductive traces may couple the first plurality of frequency multipliers to the first plurality of transmit RF antennas.

In some embodiments, the first plurality of frequency multipliers (e.g., 966) comprises a plurality of frequency doublers configured to convert the first amplified RF signals to the first RF center frequency from a second RF center frequency that is one-half of the first RF center frequency. For example, the first plurality of RF amplifiers may be advantageously operated at one-half of the first RF center frequency where higher power gain may be obtained than at the first center RF frequency. For instance, the first RF center frequency may be 310 GHz and the second RF center frequency may be 155 GHz.

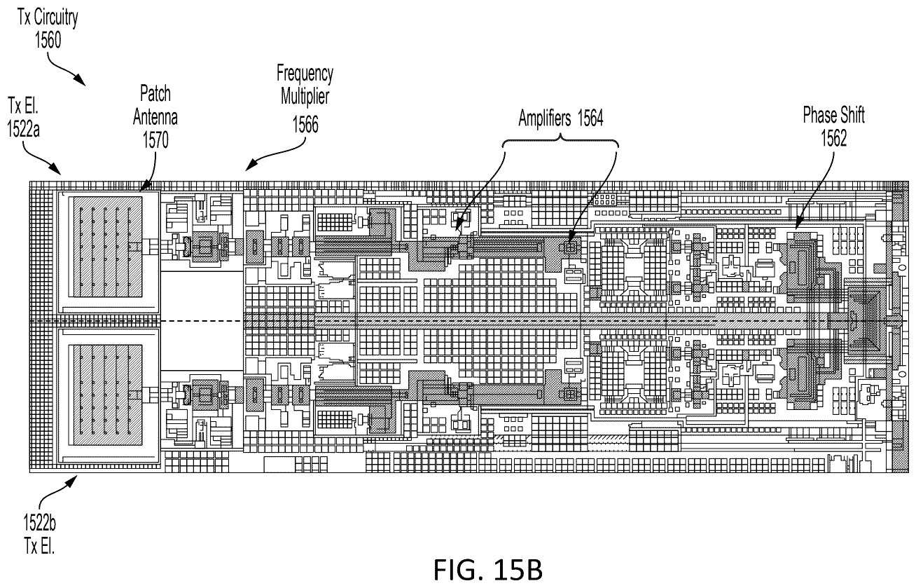

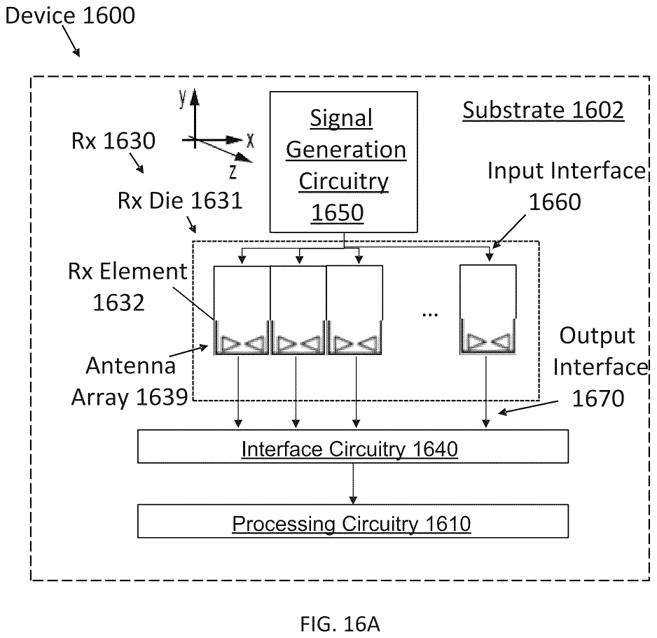

In some embodiments, the transmitter (e.g., 1520 in FIG. 15A) further comprises a second transmit semiconductor die (e.g., 1521c) spaced at a distance from the first transmit semiconductor die (e.g., 1521a) in the first direction (e.g., the y-direction in FIG. 15A), the second transmit semiconductor die having integrated thereon: (A) a second transmit antenna array (e.g., 1532) comprising a second plurality of RF antennas (e.g., 1570 in FIG. 15B) configured to transmit second RF signals having the first RF center frequency; and (B) second transmit circuitry (e.g., 1560 in FIG. 15B) configured to generate, based on the reference RF signal, the second RF signals, the second transmit circuitry comprising: a second plurality of RF amplifiers (e.g., 1564) configured to drive the second plurality of RF antennas with second amplified RF signals; and a second plurality of frequency multipliers (e.g., 1566) coupled between the second plurality of RF amplifiers and the second plurality of RF antennas and configured to convert the second amplified RF signals from the second plurality of RF amplifiers to the first RF center frequency to obtain the second RF signals.

In some embodiments, the RADAR device (e.g., 200 in FIG. 2) further comprises a receiver (e.g., 230) mounted on the substrate, the receiver comprising: a first receive semiconductor die (e.g., 1631 in FIG. 16A) having integrated thereon: a first receive antenna array (e.g., 1639) comprising a first plurality of receive RF antennas (e.g., 1686 in FIG. 16B) configured to receive third RF signals having the first RF center frequency; and first receive circuitry (e.g., 1680 in FIG. 16B) configured to mix the third RF signals with fourth RF signals, generated based on the reference RF signal, to obtain fifth RF signals.

In some embodiments, the RADAR device (e.g., 200 in FIG. 2) further comprises processing circuitry (e.g., 210) mounted on the substrate (e.g., 202) and configured to determine, based on the fifth RF signals, a distance between the RADAR device and a target object (e.g., 106 in FIG. 1) that reflected the first RF signals to generate, at least in part, the third RF signals.

In some embodiments, the transmitter (e.g., 1520 in FIG. 15A) comprises a first column of transmit semiconductor dies (e.g., 1521a-1521c), comprising the first transmit semiconductor die (e.g., 1521b), that is tiled in the first direction (e.g., the y-direction in FIGS. 2 and 15A), and wherein the receiver (e.g., 230 in FIG. 2) comprises a first row of receive semiconductor dies (e.g., 1631 in FIG. 16A), comprising the first receive semiconductor die, that is tiled in the second direction (e.g., the x-direction in FIG. 2).

In some embodiments, the first RF center frequency is in a range of 190 to 300 GHz, 300 to 320 GHz, 390 to 450 GHz, 440 to 480 GHz, 455 to 495 GHz, 660 to 700 GHz, or 820 to 880 GHz. In some embodiments, the first RF center frequency is between 300 GHz and 320 GHz. In some embodiments, the first RF signals have a bandwidth of at least 2 GHz, at least 3 GHZ, or at least 6 GHz.

Some embodiments provide for a method for use with a RADAR device (e.g., 900 in FIG. 9), the RADAR device comprising a substrate (e.g., 902) having signal generation circuitry (e.g., 950) and a transmitter (e.g., 920) mounted thereon, the substrate defining a plane extending in a first direction (e.g., the y-direction in FIG. 9) and a second direction (e.g., the x-direction in FIG. 9) that are orthogonal to one another, the transmitter comprising a first transmit semiconductor die (e.g., 1021 in FIG. 10A) having integrated thereon a first transmit antenna array (e.g., 970) and first transmit circuitry (e.g., 960), the first transmit antenna array comprising a first plurality of transmit RF antennas (e.g., 972), and the first transmit circuitry comprising a first plurality of RF amplifiers (e.g., 964) and a first plurality of frequency multipliers (e.g., 966) coupled between the first plurality of RF amplifiers and the first plurality of transmit RF antennas, the method comprising: (A) generating, using the signal generation circuitry, a reference RF signal; (B) transmitting, using the first plurality of transmit RF antennas, first RF signals having a first RF center frequency in a particular frequency range within a range of 150 GHz to 1.5 THz; (C) driving, using the first plurality of RF amplifiers, the first plurality of transmit RF antennas with first amplified RF signals based on the reference RF signal; and (D) converting, using the first plurality of frequency multipliers, the first amplified RF signals from the first plurality of RF amplifiers to the first RF center frequency to obtain the first RF signals.

In some embodiments, the first plurality of frequency multipliers are coupled directly to the first plurality of transmit RF antennas (e.g., FIG. 9), and the method further comprises providing, by the first plurality of frequency multipliers, the first RF signals to the first plurality of transmit RF antennas.

In some embodiments, the first plurality of frequency multipliers comprises a plurality of frequency doublers, and converting the first amplified RF signals to the first RF center frequency comprises converting the first amplified RF signals to the first RF center frequency from a second RF center frequency that is one-half of the first RF center frequency.

In some embodiments, the transmitter (e.g., 1520 in FIG. 15A) further comprises a second transmit semiconductor die (e.g., 1521c) spaced at a distance from the first transmit semiconductor die (e.g., 1521a) in the first direction (e.g., the y-direction in FIG. 15A), the second transmit semiconductor die having integrated thereon a second transmit antenna array (e.g., 1532) and second transmit circuitry (e.g., 1560 in FIG. 15B), the second transmit antenna array comprising a second plurality of RF antennas (e.g., 1570 in FIG. 15B), and the second transmit circuitry comprising a second plurality of RF amplifiers (e.g., 1564) and a second plurality of frequency multipliers (e.g., 1566) coupled between the second plurality of RF amplifiers and the second plurality of RF antennas; and the method further comprises: transmitting, using the second plurality of RF antennas, second RF signals having the first RF center frequency; driving, using the second plurality of RF amplifiers, the second plurality of RF antennas with second amplified RF signals based on the reference RF signal; and converting, using the second plurality of frequency multipliers, the second amplified RF signals from the second plurality of RF amplifiers to the first RF center frequency to obtain the second RF signals.

In some embodiments, the RADAR device (e.g., 200 in FIG. 2) further comprises a receiver (e.g., 230) mounted on the substrate (e.g., 202), the receiver comprising a first receive semiconductor die (e.g., 1631 in FIG. 16A) having integrated thereon a first receive antenna array (e.g., 1639) comprising a first plurality of receive RF antennas (e.g., 1686 in FIG. 16B) and first receive circuitry (e.g., 1680 in FIG. 16B); and the method further comprises: receiving, using the first plurality of receive RF antennas, third RF signals having the first RF center frequency; and mixing, using the first receive circuitry, the third RF signals with fourth RF signals, generated based on the reference RF signal, to obtain fifth RF signals.

In some embodiments, the RADAR device (e.g., 200 in FIG. 2) further comprises processing circuitry (e.g., 210) mounted on the substrate (e.g., 202); and the method further comprises determining, using the processing circuitry, based on the fifth RF signals, a distance between the RADAR device and a target object (e.g., 106 in FIG. 1) that reflected the first RF signals to generate, at least in part, the third RF signals.

In some embodiments, the first RF center frequency is in a range of 190 to 300 GHz, 300 to 320 GHz, 390 to 450 GHz, 440 to 480 GHz, 455 to 495 GHz, 660 to 700 GHz, or 820 to 880 GHz. In some embodiments, the first RF center frequency is between 300 GHz and 320 GHz. In some embodiments, the first RF signals have a bandwidth of at least 2 GHz, at least 3 GHz, or at least 6 GHz.

Some embodiments provide for a RADAR device (e.g., 200 in FIG. 2), comprising: (A) a substrate (e.g., 202) defining a plane extending in a first direction (e.g., y-direction in FIG. 2) and a second direction (e.g., x-direction in FIG. 2) that are orthogonal to one another; (B) signal generation circuitry (e.g., 250) mounted on the substrate and configured to generate a reference RF signal; (C) a transmitter (e.g., 220) mounted on the substrate, the transmitter comprising: a first transmit semiconductor die (e.g., 1021 in FIG. 10A) having integrated thereon: a first transmit antenna array (e.g., 1032) comprising a first plurality of transmit RF antennas (e.g., 1072 in FIG. 10B) configured to transmit first RF signals having a first RF center frequency in a particular frequency range within a range of 150 GHz to 1.5 THz; and first transmit circuitry (e.g., 1060 in FIG. 10B) comprising: a first plurality of RF amplifiers (e.g., 1064) configured to drive the first plurality of transmit RF antennas with first amplified RF signals based on the reference RF signal; and a first plurality of frequency multipliers (e.g., 1066) coupled between the first plurality of RF amplifiers and the first plurality of transmit RF antennas and configured to convert the first amplified RF signals from the first plurality of RF amplifiers to the first RF center frequency to obtain the first RF signals; (D) a receiver (e.g., 230) mounted on the substrate, the receiver comprising: a first receive semiconductor die (e.g., 1631 in FIG. 16A) having integrated thereon: a first receive antenna array (e.g., 1639) comprising a first plurality of receive RF antennas (e.g., 1686 in FIG. 16B) configured to receive second RF signals having the first RF center frequency; and first receive circuitry (e.g., 1680) configured to mix the second RF signals with third RF signals, generated based on the reference RF signal, to obtain fourth RF signals; (E) interface circuitry (e.g., 240 in FIG. 2) mounted on the substrate and coupled to the first receive circuitry, the interface circuitry comprising analog-to-digital conversion (ADC) circuitry configured to digitize the fourth RF signals to obtain digitized fourth RF signals; and (F) processing circuitry (e.g., 210) mounted on the substrate and coupled to the interface circuitry, the processing circuitry configured to determine, based on the digitized fourth RF signals, a distance between the RADAR device and a target object (e.g., 106 in FIG. 1) that reflected the first RF signals to generate, at least in part, the second RF signals.

FIG. 9 illustrates example circuitry including signal generation circuitry 950 and a TX 920 that may be included in a radar device, e.g., 900, in accordance with some embodiments of the technology described herein.

In some embodiments, device 900 may be configured as described herein for device 200, including in connection with FIG. 2. For example, as shown in FIG. 9, device 900 includes a substrate 902 having signal generation circuitry 950 and TX 920 mounted thereon. In some embodiments, signal generation circuitry 950 may be configured to generate a reference RF signal, such as described herein for signal generation circuitry 250 including in connection with FIG. 2.

As shown in FIG. 9, TX 920 includes transmit antenna array 970 and transmit circuitry 960. In some embodiments, transmit antenna array 970 may include a plurality of transmit RF antennas configured to transmit first RF signals having a first RF center frequency in a particular frequency range within a range of 150 GHz to 1.5 THz. For example, the first RF center frequency may be in a range of 190 to 300 GHz, 300 to 320 GHz, 390 to 450 GHz, 440 to 480 GHz, 455 to 495 GHz, or 820 to 880 GHz. For instance, the first RF center frequency may be between 300 GHz and 320 GHz, such as 310 GHz. In some embodiments, the first RF signals have a bandwidth of at least 2 GHz (e.g., 2.5 GHZ), at least 3 GHZ, or at least 6 GHz.

In some embodiments, transmit circuitry 960 may include a plurality of RF amplifiers configured to drive the first plurality of transmit RF antennas with first amplified RF signals based on the reference RF signal. For example, as shown in FIG. 9, transmit circuitry 960 includes a first RF amplifier 964 coupled to a first transmit RF antenna 972, which may be configured to drive first transmit RF antenna 972 with a signal based on a reference RF signal generated by signal generation circuitry 950. For example, first RF amplifier 964 may be configured to obtain, amplify, and drive first transmit RF antenna 972 with a frequency-multiplied version of the reference RF signal. For instance, the reference RF signal may include an intermediate frequency (IF) LFM signal (e.g., chirp) and the version obtained by first RF amplifier 964 may have a center frequency closer to (e.g., one half of) the first RF center frequency at which first transmit RF antenna 972 is configured to transmit.

In some embodiments, transmit circuitry 960 may further include a first plurality of frequency multipliers coupled between the first plurality of RF amplifiers and the first plurality of transmit RF antennas and configured to convert the first amplified RF signals from the first plurality of RF amplifiers to the first RF center frequency to obtain the first RF signals. For example, as shown in FIG. 9, transmit circuitry 960 includes a first frequency multiplier 966 coupled between first RF amplifier 964 and first transmit RF antenna 972. For instance, first frequency multiplier 966 may be configured to convert the first amplified RF signal output by first RF amplifier 964 to the first RF center frequency, such as using non-linear harmonic generation (e.g., second harmonic generation).

In some embodiments, frequency multipliers of transmit circuitry 960 may be coupled directly to transmit RF antennas of transmit antenna array 970. For example, as shown in FIG. 9, no active circuitry (e.g., amplifiers) is coupled between first frequency multiplier 966 and first transmit RF antenna 972. For instance, only conductive traces may be coupled between first frequency multiplier 966 and first transmit RF antenna.to provide the first RF signals to the first plurality of transmit RF antennas. In some embodiments, performing most or all amplification prior to frequency multiplication facilitates high power gain amplification at a center frequency lower than the center frequency at which RF signals are transmitted where high power gain amplification may not be as efficient.

In some embodiments, frequency multipliers of transmit circuitry 960 may include frequency doublers configured to convert the first amplified RF signals to the first RF center frequency from a second RF center frequency that is one-half of the first RF center frequency. For example, RF amplifiers of transmit circuitry 960 may be advantageously operated at one-half of the first RF center frequency, where high power gain may be obtained more efficiently than at the first center RF frequency. For instance, the first RF center frequency may be 310 GHz and the second RF center frequency may be 155 GHz.

In some embodiments, transmit circuitry 960 and transmit antenna array 970 may include a plurality of transmit channel elements. For example, as shown in FIG. 9, first RF amplifier 964, first frequency multiplier 966, and first transmit RF antenna 972 are included in a first transmit channel element 922. In some embodiments, transmit antenna array 970 and transmit circuitry 960 may be integrated on a transmit semiconductor die, such as described further herein including in connection with FIGS. 10A-10B.

While not shown in FIG. 9, in some embodiments, device 900 may further include a receiver (e.g., 230 in FIG. 2) mounted on substrate 902. For example, the receiver may be configured as described further herein including in connection with FIGS. 16A-16B. Similarly, in some embodiments, device 900 may further include processing circuitry (e.g., 210 in FIG. 2) mounted on substrate 902. For example, the processing circuitry may be configured to determine, based on RF signals processed using the receiver, a distance between device 900 and a target object (e.g., 106 in FIG. 1), such as described herein including in connection with FIGS. 1-6. FIG. 10A illustrates example circuitry including signal generation circuitry 1050 and a TX 1020 having a transmit semiconductor die 1021 that may be included in a radar device, e.g., 1000, in accordance with some embodiments of the technology described herein.

In some embodiments, device 1000 may be configured as described herein for device 200, 700, and/or 900 including in connection with FIGS. 2 and 7-9. For example, as shown in FIG. 10A, device 1000 includes substrate 1002 having mounted thereon signal generation circuitry 1050 and TX 1020.

In some embodiments, TX 1020 may have a transmit semiconductor die having integrated thereon transmit circuitry (1060, FIG. 10B) configured to generate RF signals based on a reference RF signal and a transmit antenna array having RF antennas configured to transmit the RF signals. For example, as shown in FIG. 10A, TX 1020 has a transmit semiconductor die 1021 with a plurality of transmit elements 1022 and transmit antenna array 1032. For instance, each transmit element 1022 may have a portion of the transmit circuitry configured to feed a respective transmit antenna of transmit antenna array 1032.

In some embodiments, an RF transmit antenna array may have a transmit aperture with a transmit aperture length extending in a first direction and a transmit aperture width extending in a second direction, the transmit aperture length being larger than the transmit aperture width. For example, as shown in FIG. 10A, antenna array 1032 has more antennas in the y-direction than in the x-direction, which may provide a larger transmit aperture length in the y-direction than transmit aperture width in the x-direction.

In some embodiments, RF transmit antenna array may be arranged in a two-dimensional grid. For example, as shown in FIG. 10A, transmit antenna array 1032 is arranged in first and second columns 1006a and 1006b extending in the first direction (e.g., y-direction), with each column having multiple rows extending in the second direction (e.g., x-direction). In some embodiments, the RF transmit circuitry onboard transmit semiconductor die 1021 may be further arranged in the two-dimensional grid. For example, transmit circuitry of transmit elements 1022 may be arranged in a first transmit circuitry portion in first column 1006a and configured to feed the antennas in first column 1006a and a second transmit circuitry portion in second column 1006b configured to feed the antennas in second column 1006b. For instance, the first transmit circuitry portion may include the transmit circuitry of transmit elements 1022 shown in first column 1006a in FIG. 10A and the second transmit circuitry portion may include the transmit circuitry of transmit elements 1022 shown in second column 1006b in FIG. 10A. In FIG. 10A, first and second columns 1006a and 1006b have 8 rows, though it should be appreciated that any number of rows may be included, such as two or more rows (e.g., more rows than columns). In some embodiments, an RF transmit antenna array arranged in a two-dimensional grid may have a larger area aperture than a one-dimensional array with the same number of transmit elements, resulting in high antenna gain for efficient operation.

In some embodiments, transmit semiconductor die 1021 may further include multiple interfaces configured to receive a reference RF signal from signal generation circuitry 1050 and provide the reference RF signal to transmit elements 1022. For example, in FIG. 10A, transmit semiconductor die 1021 has a first interface 1050a and a second interface 1050b, with first interface 1050a coupled between signal generation circuitry 1050 and transmit elements 1022 of first column 1006a and second interface 1050b coupled between signal generation circuitry 1050 and transmit elements 1022 of second column 1006b.

In some embodiments, first interface 1050a may be positioned within a threshold distance of a first outer edge of transmit semiconductor die 1021 and second interface 1050b may be positioned within the threshold distance of a second outer edge of transmit semiconductor die 1021 opposite the first outer edge. For example, as shown in FIG. 10A, transmit semiconductor die 1021 has a first outer edge 1026a and a second outer edge 1026b that is opposite first outer edge 1026a (e.g., along the x-direction), and first interface 1050a includes a first power divider 1054a disposed proximate first outer edge 1026a and second interface 1050b includes a second power divider 1054b disposed proximate second outer edge 1026b. In some embodiments, first power divider 1054a may be positioned within a threshold distance of first outer edge 1026a and second power divider 1054b may be positioned within the threshold distance of second outer edge 1026b. For instance, the threshold distance may be a distance from the outer edge of the die in which bond pads are disposed for connecting to substrate 1002 (e.g., via wire bond). It should be appreciated that first and second power dividers 1054a and 1054b may both be within the same threshold distance of respective outer edges 1026a and 1026b without necessarily being spaced identically from respective outer edges 1026a and 1026b (e.g., one power divider may be more closely spaced to the respective outer edge).

In some embodiments, power dividers of transmit semiconductor die 1021 may be configured to divide a reference RF signal from signal generation circuitry 1050 into a plurality of reference RF signals and provide the plurality of reference RF signals to transmit circuitry of transmit semiconductor die 1021 for feeding antenna array 1032. For example, power divider 1054a may be configured to receive a reference RF signal from signal generation circuitry 1050 (e.g., via bonds pads at first outer edge 1026a), divide the reference RF signal into a reference RF signal for each respective antenna of first column 1006a, and provide the reference RF signals to the respective antennas of first column 1006a. Similarly, power divider 1054b may be configured to receive the reference RF signal from signal generation circuitry 1050 (e.g., via bond pads at second outer edge 1026b), divide the reference RF signal into a reference RF signal for each respective antenna of second column 1006b, and provide the reference RF signals to the respective antennas of second column 1006b. For instance, as shown in FIG. 10A, first and second columns 1006a and 1006b have 8 rows of transmit elements 1022, and power dividers 1054a and 1054b are each configured as a 1-to-8 (1:8) power divider. It should be appreciated that each conductive path of power divider 1054a and 1054b may have the same length such that the reference RF signals reach each transmit element 1022 in-phase with one another.

While a single transmit semiconductor die 1021 is shown in FIG. 10A, a device may have multiple transmit semiconductor dies 1021 shown as configured in FIG. 10A (e.g., 1521 in FIG. 15A), such as may be organized into one or more columns (e.g., 224a and 224b in FIG. 2). For example, transmit semiconductor die 1021 may be a first die (e.g., 1521a in FIG. 15A) and device 1000 may further include a second transmit semiconductor die (e.g., 1521b) configured as described herein for die 1021.

While signal generation circuitry 1050 is shown on the same substrate 1002 as transmit semiconductor die 1021 in FIG. 10A, signal generation circuitry 1050 may be on a separate substrate in some embodiments.

In some embodiments, device 1000 may further have a receiver (e.g., 230 in FIG. 2) with a receive antenna array and receive circuitry, such as described further herein. In some embodiments, device 1000 may further include processing circuitry (e.g., 210 in FIG. 2) configured to determine, based on RF signals processed using the receiver, a distance between device 900 and a target object (e.g., 106 in FIG. 1), such as described herein including in connection with FIGS. 1-6. Alternatively or additionally, in some embodiments, device 1000 may include interface circuitry (e.g., 240 in FIG. 2). For example, the interface circuitry and/or processing circuitry may be mounted on substrate 1002.

FIG. 10B illustrates example transmit circuitry 1060 that may be included in TX 1020, in accordance with some embodiments of the technology described herein.

In some embodiments, interface 1050a may further include frequency multiplication circuitry configured to up-convert a reference RF signal from signal generation circuitry 1050 to a center frequency of or closer to the center frequency of transmission. For example, where signal generation circuitry 1050 and transmit semiconductor die 1021 are mounted on substrate 1002, the reference RF signal may be propagated from signal generation circuitry 1050 to transmit semiconductor die 1021 using traces on substrate 1002, which may not have suitable characteristics for propagating signals at THz frequencies. Rather, in some embodiments, the reference RF signal may be propagated from signal generation circuitry 1050 to transmit semiconductor die 1021 at a relatively low center frequency (e.g., 17.22 GHZ), and interface 1050a may have a frequency multiplier 1052a configured to up-convert the reference RF signal to a center frequency (e.g., 155 GHZ) closer to transmit center frequency (e.g., 310 GHz). In the illustrated embodiment, frequency multiplier 1052a is configured to provide the up-converted reference RF signal to power divider 1054a to be divided among transmit elements 1022. For example, frequency multiplication may be less noisy to perform a signal having a large power level (e.g., prior to power division).

In some embodiments, transmit semiconductor die 1021 may have transmit circuitry 1060 configured to generate RF signals based on the reference RF signal obtained from signal generation circuitry 1050 and feed the RF signals to transmit antenna array 1032. For example, as shown in FIG. 10B, transmit element 1022 includes an antenna 1072 of transmit antenna array 1032 coupled to a phase shifter 1062, amplifier 1064, and frequency multiplier 1066 of transmit circuitry 1060. In the illustrated example of FIG. 10B, transmit circuitry 1060 further includes a feedback circuit 1068 coupled to frequency multiplier 1066, which may be configured to regulate a bias state (e.g., bias current) of frequency multiplier 1066, such as described herein for feedback circuits 732 and 832 including in connection with FIGS. 7-8.

In some embodiments, phase shifter 1062 may be configured to introduce a beamforming phase shift to RF signals transmitted by antenna 1072, such as with phase shifters 1062 of some or all transmit elements 1022 providing a different phase shift so as to steer transmitted RF signals at a particular angle (e.g., in elevation and/or azimuth). In some embodiments, amplifier 1064 may be configured to add power to phase shifted signals prior to multiplication by frequency multiplier 1066, which may mitigate at least some noise from frequency multiplication.

In some embodiments, frequency multiplier 1066 may be configured to output an RF signal having a center frequency desired for transmission via antenna 1072. For example, in FIG. 10B, some frequency multiplication to reach the center frequency desired for transmission may be performed by frequency multiplier 1052a of interface 1050a and some frequency multiplication may be performed by frequency multiplier 1066. For instance, a 9× multiplication may be performed by frequency multiplier 1052a (e.g., from 17.22 GHz to 155 GHZ), and a 2× multiplication (e.g., frequency doubling) may be performed by frequency multiplier 1066. For instance, frequency multiplication by a larger scalar may be performed with less noise impact on signals having higher power levels, such as 9× multiplication on an obtained reference RF signal at full power followed by 2× multiplication on several reference RF signals divided from the reference RF signal into smaller power levels.

As shown in FIG. 10B, frequency multiplier 1066 may be coupled between amplifier 1064 and antenna 1072, such as described herein including in connection with FIG. 9. In some embodiments, frequency multiplier 1066 may be configured to generate an RF signal for transmission via antenna 1072 at least in part by generating a harmonic of a reference RF signal, the harmonic having a center frequency of the RF signal for transmission, such as described herein including in connection with frequency multiplier 966 including in connection with FIG. 9.

While not shown in FIG. 10B, it should be appreciated that power divider 1054a may be coupled to the transmit elements 1022 of first column 1006a, and that power divider 1054b may be coupled to transmit elements 1022 of second column 1006b and configured as described herein for (e.g., mirrored with respect to) the portion of device 1000 shown in FIG. 10B. Moreover, each transmit semiconductor die 1021 may include feedback circuits (e.g., 1068) coupled to frequency multipliers (e.g., 1066) within some or all transmit elements 1022 of the transmit semiconductor die 1021. For instance, some or all frequency multipliers across the multiple transmit semiconductor dies 1021 may be configured to generate a harmonic based on a reference RF signal from signal generation circuitry 1050.

### Frequency Multiplier Transistor Circuit Configuration

As described above, the inventors have developed solutions to improve the operating efficiency of a Terahertz RADAR device. The inventors have recognized that switching electronics (e.g., frequency multipliers) in a transmitter and/or receiver of a conventional RADAR device do not operate efficiently at THz frequencies, at least in part because efficiency declines significantly as the frequency of operation approaches the maximum switching frequency of the transistor technology. One might implement a frequency multiplier using a common-emitter (e.g., bipolar transistor) and/or common-source (e.g., field-effect transistor) configuration, which provides good conversion gain (e.g., from power at DC and/or at a first center frequency to a harmonic thereof) at sub-THz frequencies, but provides significantly worse conversion gain when operated at THz frequencies at which the converted signals may be transmitted. The inventors have recognized that such transistor configurations lose input power from the control terminal (e.g., base or gate) to the channel terminal (e.g., emitter or source) used to switch the transistor, as the output of the transistor configuration is drawn from the other channel terminal (e.g., collector or drain). In the example of a bipolar transistor, the inventors have recognized that the ratio of base current to collector current (commonly termed “Beta”) varies inversely with frequency at THz frequencies, such that the amount of current input to the base that is lost by drawing the output at the collector is significant.

Accordingly, some aspects of the present disclosure relate to using certain (e.g., common-collector, common-drain) transistor configurations in a frequency multiplier (e.g., of a transmitter). For example, such transistor configurations have a transistor circuit including a control terminal configured to obtain a reference RF signal, a first channel terminal configured to generate an RF signal having an RF center frequency (e.g., that is a harmonic of a center frequency of the reference RF signal), and a second channel terminal, with the control terminal and the first channel terminal being configured to control coupling between the first channel terminal and the second channel terminal. For instance, the transistor circuit may include a bipolar (e.g., heterojunction bipolar) transistor in a common-collector configuration, such that the base is configured to receive the reference RF signal (e.g., directly or via field-effect transistors in a BiCMOS configuration) and the emitter is configured to generate the RF signal.

In such transistor configurations, power from an input signal (e.g., at a center frequency of the reference RF signal) applied to the frequency multiplier at the control terminal may be efficiently and advantageously conserved in the RF signal generated at the first channel terminal and output from the frequency multiplier. For example, current that is input to the control terminal in the reference RF signal is output from the first channel terminal to switch the transistor, and thus the current that switches the transistor also contributes to the power output from the first channel terminal in the RF signal, resulting in high efficiency conversion. In contrast, some other transistor configurations (e.g., common-emitter, common source) lose input power by outputting current at the first channel terminal that does not contribute to the output of the frequency multiplier when the output is obtained at the second channel terminal (e.g., collector or drain). In some embodiments, such configurations achieve high conversion gain using existing transistor technologies in the same or similar bias states (e.g., applied bias voltage and/or bias current) as in previous transistor circuit configurations (e.g., common-emitter or common-drain).

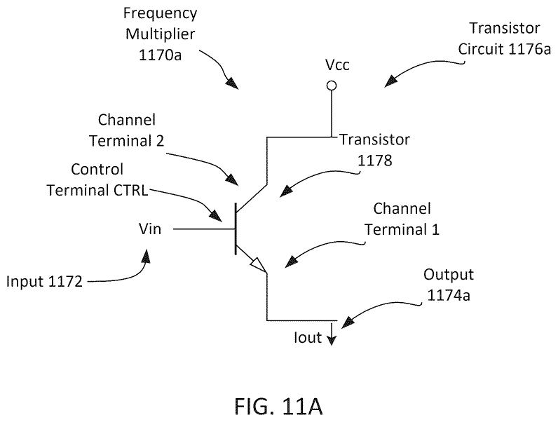

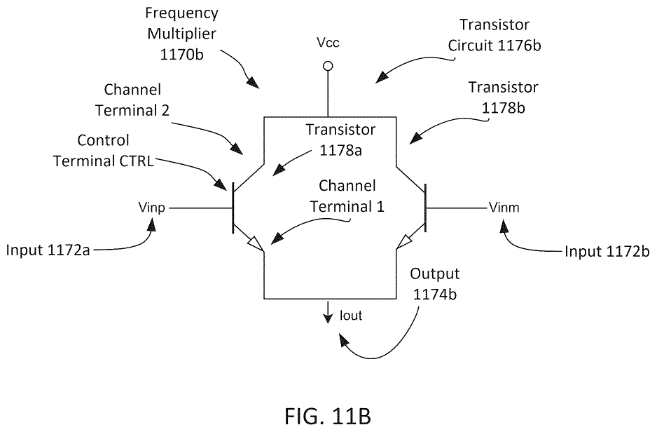

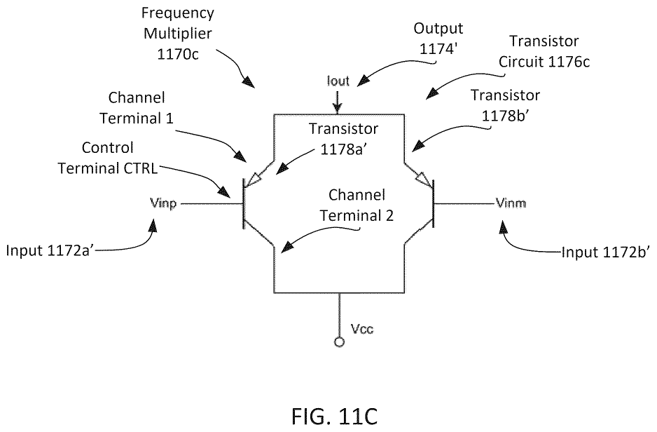

Accordingly, some embodiments provide for a RADAR device (e.g., 1000), comprising: (A) a substrate (e.g., 1002) defining a plane extending in a first direction (e.g., the y-direction in FIG. 10A) and a second direction (e.g., the x-direction in FIG. 10A) that are substantially orthogonal to one another; and (B) a transmitter (e.g., 1020) mounted on the substrate, the transmitter comprising: a first transmit semiconductor die (e.g., 1021) having integrated thereon: first transmit circuitry (e.g., 1060 in FIG. 10B) configured to generate first RF signals having a first RF center frequency in a particular frequency range within a range of 300 GHz to 1.5 THz, the first transmit circuitry comprising: a first frequency multiplier (e.g., 1170a in FIG. 11A) comprising an input (e.g., 1172), an output (e.g., 1174a), and a transistor circuit (e.g., 1176a), the transistor circuit comprising: a control terminal (e.g., CTRL in FIG. 11A) configured to obtain a reference RF signal at the input; a first channel terminal (e.g., channel terminal 1 in FIG. 11A) configured to generate a first RF signal of the first RF signals at the output having the first RF center frequency; and a second channel terminal (e.g., channel terminal 2 in FIG. 11A), wherein the control terminal and the first channel terminal are configured to control coupling between the first channel terminal and the second channel terminal; and a first transmit antenna array (e.g., 1032 in FIG. 10A) comprising a first plurality of transmit RF antennas (e.g., 1072 in FIG. 10B) configured to transmit the first RF signals.

In some embodiments, the first frequency multiplier comprises a frequency doubler; and the control terminal is configured to obtain the reference RF signal having a second RF center frequency that is one-half of the first RF center frequency.

In some embodiments, the first channel terminal is configured to generate the first RF signal as not inverted with respect to (e.g., having a same phase as) the reference RF signal the control terminal is configured to obtain at the input. For example, some transistor configurations (e.g., common-collector or common-drain) may be configured to provide a non-inverting output (e.g., having the same phase as the input) such that harmonic trap circuits may not be used at the control terminal(s) of the transistor circuit.

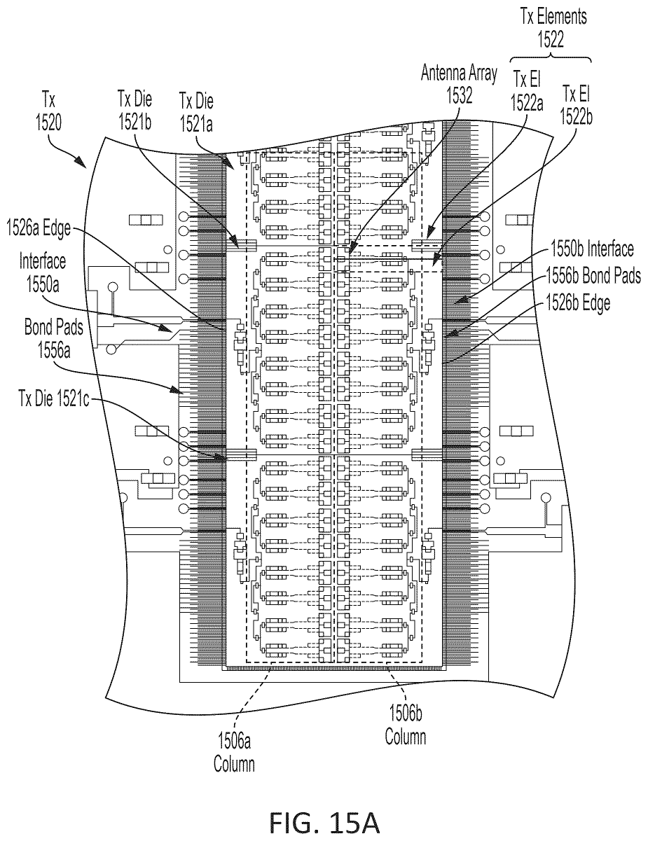

In some embodiments, the transistor circuit is configured to: output a first peak harmonic current when the transistor circuit is biased with a first bias current; and output a second peak harmonic current that is lower than the first peak harmonic current when the transistor circuit is biased with a second bias current that is higher than the first bias current (e.g., FIG. 14). For example, some transistor configurations (e.g., common-collector or common-drain) may be configured to output a higher peak harmonic current (e.g., second harmonic current) when biased with a lower bias current, which may provide efficient frequency multiplication.

In some embodiments, the transistor circuit (e.g., 1176a) comprises a heterojunction bipolar transistor (HBT) circuit comprising a base coupled to the input (e.g., 1172), an emitter coupled to the output (e.g., 1174a), and a collector; and the base and the emitter are configured to control coupling between the collector and the emitter.

In some embodiments, the RADAR device (e.g., 1000 in FIG. 10A) further comprises signal generation circuitry (e.g., 1050) mounted on the substrate (e.g., 1002) and configured to generate the reference RF signal.

In some embodiments, the RADAR device (e.g., 200 in FIG. 2) further comprises a receiver (e.g., 230) mounted on the substrate (e.g., 202), the receiver comprising: a first receive semiconductor die (e.g., 1631 in FIG. 16A) having integrated thereon: a first receive antenna array (e.g., 1639) comprising a first plurality of receive RF antennas (e.g., 1686 in FIG. 16B) configured to receive second RF signals having the first RF center frequency; and first receive circuitry (e.g., 1680 in FIG. 16B) configured to mix the second RF signals with third RF signals, generated based on the reference RF signal, to obtain fourth RF signals.

In some embodiments, the RADAR device (e.g., 200 in FIG. 2) further comprises processing circuitry (e.g., 210) mounted on the substrate (e.g., 202) and configured to determine, based on the fourth RF signals, a distance between the RADAR device and a target object (e.g., 106) that reflected the first RF signals to generate, at least in part, the second RF signals. In some embodiments, the transmitter (e.g., 1520 in FIG. 15A) comprises a first column of transmit semiconductor dies (e.g., 1521a-1521c), comprising the first transmit semiconductor die (e.g., 1521b), that is tiled in the first direction (e.g., the y-direction in FIGS. 2 and 15A), and wherein the receiver (e.g., 230 in FIG. 2) comprises a first row of receive semiconductor dies (e.g., 1631 in FIG. 16A), comprising the first receive semiconductor die, that is tiled in the second direction (e.g., the x-direction in FIG. 2).

In some embodiments, the first RF center frequency is between 300 GHz and 320 GHZ, such as 310 GHz. In some embodiments, the first RF signals have a bandwidth of at least 2 GHZ, at least 3 GHz, or at least 6 GHz.

Some embodiments provide for a method for use with a device (e.g., 1000), the device comprising a substrate (e.g., 1002) having a transmitter (e.g., 1020) mounted thereon, the substrate defining a plane extending in a first direction (e.g., the y-direction in FIG. 10A) and a second direction (e.g., the x-direction in FIG. 10A) that are substantially orthogonal to one another, the transmitter comprising a first transmit semiconductor die (e.g., 1021) having integrated thereon a first plurality of transmit RF antennas (e.g., 1072 in FIG. 10B) and first transmit circuitry (e.g., 1060), the first transmit circuitry comprising a first frequency multiplier (e.g., 1170a in FIG. 11A) comprising an input (e.g., 1172), an output (e.g., 1174a), and a transistor circuit (e.g., 1176a), and the transistor circuit comprising a control terminal (e.g., CTRL in FIG. 11A), a first channel terminal (e.g., channel terminal 1 in FIG. 11A), and a second channel terminal (e.g., channel terminal 2 in FIG. 11A), the method comprising:

(A) generating, using the first transmit circuitry, first RF signals having a first RF center frequency in a particular frequency range within a range of 300 GHz to 1.5 THz at least in part by: obtaining, using the control terminal of the transistor circuit, a reference RF signal at the input of the first frequency multiplier; generating, using the first channel terminal of the transistor circuit, a first RF signal of the first RF signals having the first RF center frequency at the output of the first frequency multiplier; and controlling, using the control terminal and the first channel terminal, coupling between the first channel terminal and the second channel terminal; and (B) transmitting, using the first plurality of transmit RF antennas, the first RF signals.

In some embodiments, the first frequency multiplier comprises a frequency doubler; and the control terminal of the transistor circuit obtains the reference RF signal having a second RF center frequency that is one-half of the first RF center frequency.

In some embodiments, the first channel terminal generates the first RF signal as not inverted with respect to the reference RF signal the control terminal obtains at the input.

In some embodiments, the transistor circuit comprises a heterojunction bipolar transistor (HBT) circuit (e.g., 1176a in FIG. 11A) comprising a base coupled to the input, an emitter coupled to the output, and a collector; and controlling coupling between the first channel terminal and the second channel terminal comprises, using the base and the emitter, controlling coupling between the collector and the emitter.

In some embodiments, the RADAR device (e.g., 200 in FIG. 2) further comprises a receiver (e.g., 230) mounted on the substrate (e.g., 202), the receiver comprising a first receive semiconductor die (e.g., 1631 in FIG. 16A) having integrated thereon a first receive antenna array (e.g., 1639) and first receive circuitry (e.g., 1680 in FIG. 16B), the first receive antenna array comprising a first plurality of receive RF antennas (e.g., 1686); and the method further comprises: receiving, using the first plurality of receive RF antennas, second RF signals having the first RF center frequency; and mixing, using the first receive circuitry, the second RF signals with third RF signals, generated based on the reference RF signal, to obtain fourth RF signals.

In some embodiments, the RADAR device (e.g., 200 in FIG. 2) further comprises processing circuitry (e.g., 210) mounted on the substrate (e.g., 202); and the method further comprises determining, using the processing circuitry, based on the fourth RF signals, a distance between the device and a target object (e.g., 106 in FIG. 1) that reflected the first RF signals to generate, at least in part, the second RF signals.

In some embodiments, the first RF center frequency is between 300 GHz and 320 GHz. In some embodiments, the first RF signals have a bandwidth of at least 2 GHZ, at least 3 GHz, or at least 6 GHz.

Some embodiments provide for a device (e.g., 200 in FIG. 2), comprising: (A) a substrate (e.g., 202) defining a plane extending in a first direction (e.g., the y-direction in FIG. 2) and a second direction (e.g., the x-direction in FIG. 2) that are substantially orthogonal to one another;

(B) signal generation circuitry (e.g., 250) mounted on the substrate and configured to generate a reference RF signal; (C) a transmitter (e.g., 220) mounted on the substrate, the transmitter comprising: a first transmit semiconductor die (e.g., 1021 in FIG. 10A) having integrated thereon: first transmit circuitry (e.g., 1060 in FIG. 10B) configured to generate first RF signals having a first RF center frequency in a particular frequency range within a range of 300 GHz to 1.5 THz, the first transmit circuitry comprising: a first frequency multiplier (e.g., 1170a in FIG. 11A) comprising an input (e.g., 1172), an output (e.g., 1174a), and a transistor circuit (e.g., 1176a), the transistor circuit comprising: a control terminal (e.g., CTRL in FIG. 11A) configured to obtain a second reference RF signal, generated based on the reference RF signal, at the input; a first channel terminal (e.g., channel terminal 1 in FIG. 11A) configured to generate a first RF signal of the first RF signals at the output having the first RF center frequency; and a second channel terminal (e.g., channel terminal 2 in FIG. 11A), wherein the control terminal and the first channel terminal are configured to control coupling between the first channel terminal and the second channel terminal; and a first transmit antenna array (e.g., 1032 in FIG. 10A) comprising a first plurality of transmit RF antennas (e.g., 1072 in FIG. 10B) configured to transmit the first RF signals; (D) a receiver (e.g., 230 in FIG. 2) mounted on the substrate, the receiver comprising: a first receive semiconductor die (e.g., 1631 in FIG. 16A) having integrated thereon: a first receive antenna array (e.g., 1639) comprising a first plurality of receive RF antennas (e.g., 1686 in FIG. 16B) configured to receive second RF signals having the first RF center frequency; and first receive circuitry (e.g., 1680 in FIG. 16B) configured to mix the second RF signals with third RF signals, generated based on the reference RF signal, to obtain fourth RF signals; (E) interface circuitry (e.g., 240 in FIG. 2) mounted on the substrate and coupled to the first receive circuitry, the interface circuitry comprising analog-to-digital conversion (ADC) circuitry configured to digitize the fourth RF signals to obtain digitized fourth RF signals; and (F) processing circuitry (e.g., 210 in FIG. 2) mounted on the substrate and coupled to the interface circuitry, the processing circuitry configured to determine, based on the digitized fourth RF signals, a distance between the device and a target object (e.g., 106 in FIG. 1) that reflected the first RF signals to generate, at least in part, the second RF signals.

FIG. 11A illustrates an example frequency multiplier 1170a including a single-ended transistor circuit 1176a that may be included in TX 920 and/or 1020, in accordance with some embodiments of the technology described herein.

In some embodiments, frequency multiplier 1170a may be configured as described herein for frequency multiplier 1066 including in connection with FIG. 10B. For example, frequency multiplier 1170a may be included in transmit circuitry (e.g., 1060) configured to generate first RF signals having a first RF center frequency in a particular frequency range within a range of 300 GHz to 1.5 THz. For example, the first RF center frequency may be between 300 GHz and 320 GHz, such as 310 GHz, and/or the first RF signals may have a bandwidth of at least 2 GHz (e.g., 2.5 GHZ), at least 3 GHz, or at least 6 GHz. In the illustrated example of FIG. 11A, frequency multiplier 1170a includes an input 1172, an output 1174a, and a transistor circuit 1176a.

In some embodiments, frequency multiplier 1170a may be configured to obtain a reference RF signal at input 1172 and generate a first RF signal at output 1174a having the first RF center frequency. For example, as shown in FIG. 11A, transistor circuit 1176a of frequency multiplier 1170a includes a control terminal CTRL coupled to input 1172, a first channel terminal 1 coupled to output 1174a, and a second channel terminal 2. For instance, control terminal CTRL may be configured to obtain the reference RF signal at input 1172 and first channel terminal 1 may be configured to generate the first RF signal at output 1174a having the first RF center frequency. In some embodiments, the reference RF signal may be generated by signal generation circuitry (e.g., 1050) which may be mounted on the same substrate (e.g., 1002) on which transmit circuitry including frequency multiplier 1170a is mounted.

In some embodiments, frequency multiplier 1170a may include a frequency doubler. For example, control terminal CTRL may be configured to obtain the reference RF signal at input 1172 having a second RF center frequency that is one-half of the first RF center frequency of the first RF signal generated at output 1174a. In some embodiments, channel terminal 1 may be configured to generate the first RF signal as a result of non-linear (e.g., second) harmonic generation in response to receiving the reference RF signal at control terminal CTRL.

In some embodiments, control terminal CTRL and first channel terminal 1 may be configured to control coupling between first channel terminal 1 and second channel terminal 2. For example, coupling between first channel terminal 1 and second channel terminal 2 may be controlled based on a voltage difference between control terminal CTRL and first channel terminal 1. For instance, as shown in FIG. 11A, transistor circuit 1176a includes a heterojunction bipolar transistor (HBT) circuit with transistor 1178 having a base (e.g., implementing control terminal CTRL) coupled to input 1172, an emitter (e.g., implementing channel terminal 1) coupled to output 1174a, and a collector (e.g., implementing channel terminal 2), and the base and the emitter are configured to control coupling between the collector and the emitter (e.g., depending on a voltage difference between the base and emitter). It should be appreciated that alternative or additional transistor types may be used, such as metal oxide semiconductor field effect transistors (MOSFETs), bipolar junction transistors (BJTs) and/or high electron mobility transistors (e.g., HEMTs). For example, the HBT transistor circuit shown in FIG. 11A is in a common-collector configuration, in which a BJT may be similarly configured, and which may be implemented, e.g., using a MOSFET in a common-drain configuration.

In some embodiments, first channel terminal 1 of transistor circuit 1176a may be configured to generate the first RF signal as not inverted with respect to (e.g., having a same phase as) the reference RF signal that control terminal CTRL is configured to obtain at input 1172. For example, some transistor configurations (e.g., common-collector or common-drain) may be configured to provide a non-inverting output (e.g., having the same phase as the input) such that harmonic trap circuits may not be used at the control terminal(s) of the transistor circuit.

FIG. 11B illustrates an example frequency multiplier 1170b including a differential transistor circuit 1176b that may be included in TX 920 and/or 1020, in accordance with some embodiments of the technology described herein.

In some embodiments, frequency multiplier 1170b may be configured as described herein for frequency multiplier 1170a including in connection with FIG. 11A. For example, as shown in FIG. 11B, frequency multiplier 1170b includes differential inputs 1172a, 1172b, an output 1174a, and differential transistor circuit 1176b.

In some embodiments, frequency multiplier 1170b may be configured to obtain a reference RF signal at differential inputs 1172a, 1172b and generate a first RF signal at output 1174b having the first RF center frequency, such as described herein for frequency multiplier 1170a. For example, as shown in FIG. 11A, transistor circuit 1176b of frequency multiplier 1170b includes multiple transistors 1178a, 1178b in a differential pair having control terminals CTRL coupled to respective differential inputs 1172a, 1172b, first channel terminals 1 coupled to output 1174b, and second channel terminals 2. For instance, control terminals CTRL may be configured to obtain the reference RF signal at differential inputs 1172a, 1172b and first channel terminals 1 may be configured to generate the first RF signal at output 1174b having the first RF center frequency.

In some embodiments, control terminals CTRL and first channel terminals 1 may be configured to control coupling between first channel terminals 1 and second channel terminals 2, respectively, such as described herein for frequency multiplier 1170a. In some embodiments, first channel terminals 1 of transistor circuit 1176b may be configured to generate the first RF signal as not inverted with respect to (e.g., having a same phase as) the reference RF signal that control terminals CTRL are configured to obtain at differential inputs 1172a, 1172b, such as described herein for frequency multiplier 1170a.

FIG. 11C illustrates an example frequency multiplier including a differential transistor circuit of opposite conductivity type from FIGS. 11A-11B, which may be included in TX 920 and/or 1020, in accordance with some embodiments of the technology described herein.

In some embodiments, frequency multiplier 1170c may be configured as described herein for frequency multiplier 1170b including in connection with FIG. 11B. For example, as shown in FIG. 11C, frequency multiplier 1170c includes differential inputs 1172a′, 1172b′, an output 1174′, and differential transistor circuit 1176c. In contrast to differential transistor circuit 1176b of FIG. 11B which included n-channel transistors 1178a, 1178b, differential transistor circuit 1176c includes p-channel transistors 1178a′, 1178b′.

In some embodiments, frequency multiplier 1170c may be configured to obtain a reference RF signal at differential inputs 1172a′, 1172b′ and generate a first RF signal at output 1174′ having the first RF center frequency, such as described herein for frequency multiplier 1170b. In some embodiments, control terminals CTRL and first channel terminals 1 may be configured to control coupling between first channel terminals 1 and second channel terminals 2, respectively, such as described herein for frequency multiplier 1170b. In some embodiments, first channel terminals 1 of transistor circuit 1176c may be configured to generate the first RF signal as not inverted with respect to (e.g., having a same phase as) the reference RF signal that control terminals CTRL are configured to obtain at differential inputs 1172a′, 1172b′, such as described herein for frequency multiplier 1170b.

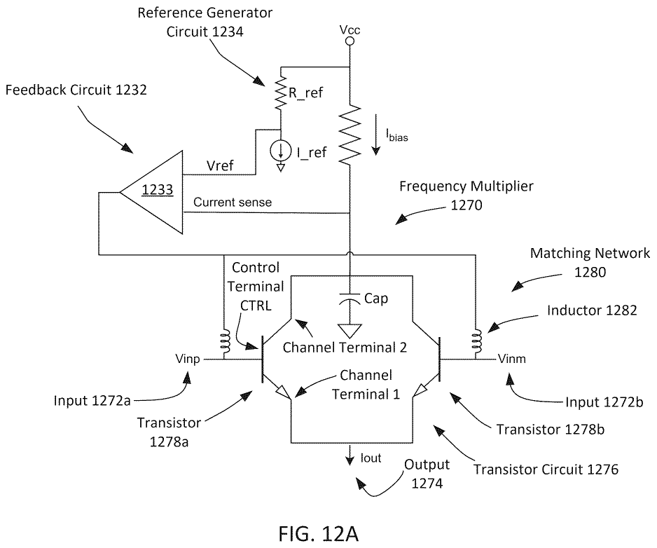

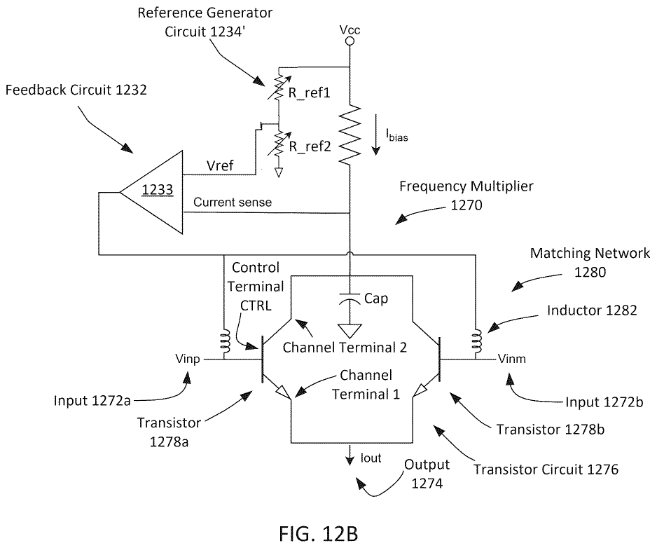

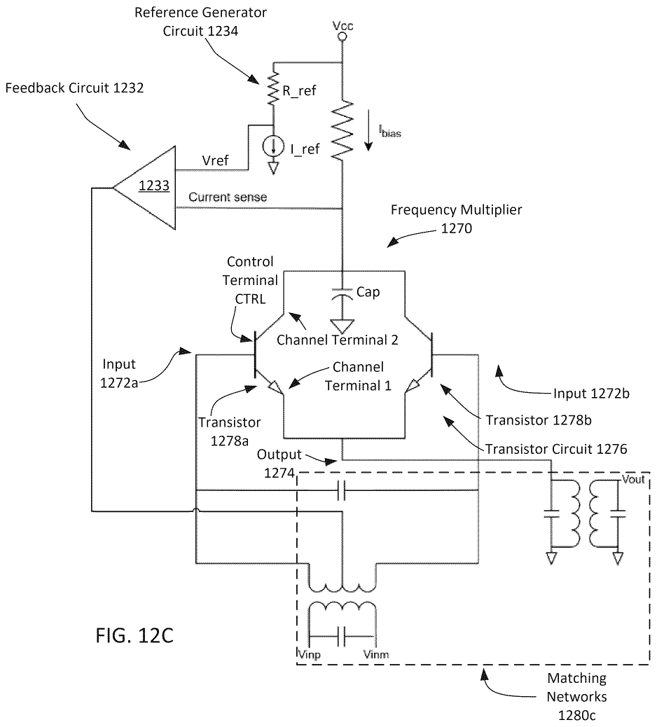

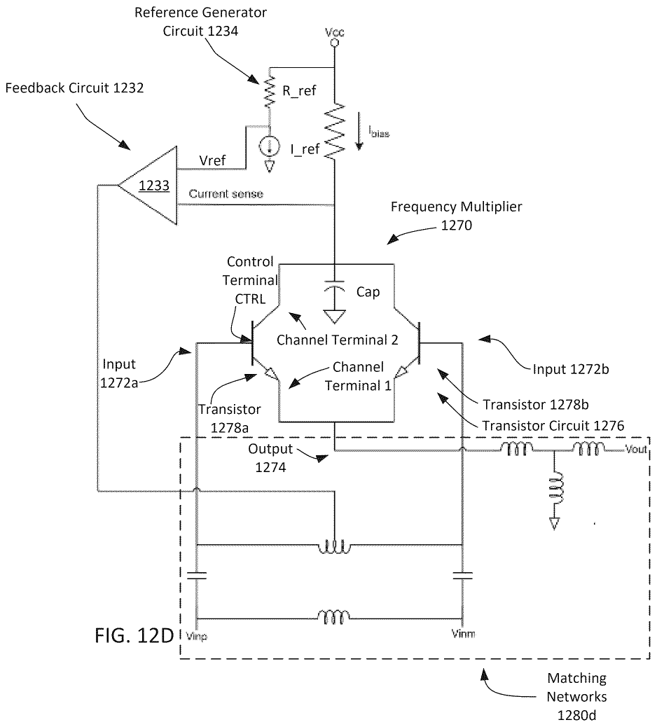

FIG. 12A illustrates an example frequency multiplier 1270 and feedback circuit 1232 that may be included in TX 920 and/or 1020, in accordance with some embodiments of the technology described herein.

In some embodiments, frequency multiplier 1270 may be configured as described herein for frequency multiplier 1170b including in connection with FIG. 11B. For example, as shown in FIG. 12A, frequency multiplier 1170b includes differential inputs 1272a, 1272b, output 1274, and transistor circuit 1276 having transistors 1278a, 1278b including control terminals CTRL coupled to differential inputs 1272a, 1272b, first channel terminal 1 coupled to output 1274, and second channel terminals 2.

In some embodiments, feedback circuit 1232 may be configured as described herein for feedback circuit 832 including in connection with FIG. 8. For example, as shown in FIG. 12A, feedback circuit 832 includes amplifier 1233 having a first input coupled to second channel terminals 2 of transistor circuit 1276, a second input configured to receive a reference voltage Vref, and an output coupled to control terminals CTRL of transistor circuit 1276.

In some embodiments, feedback circuit 1232 may include a reference generator circuit. For example, the reference generator circuit may include a voltage and/or current reference source. For instance, in FIG. 12A, feedback circuit 1232 includes a reference generator circuit 1234 configured to generate and provide reference voltage Vref to amplifier 1233. In the illustrated example, reference generator circuit 1234 includes a reference resistor R_ref and a reference current source I_ref. In some embodiments, reference current source I_ref and reference resistor R_ref may be configured to produce reference voltage Vref from current of current source I_ref passing through reference resistor R_ref to generate a voltage drop.

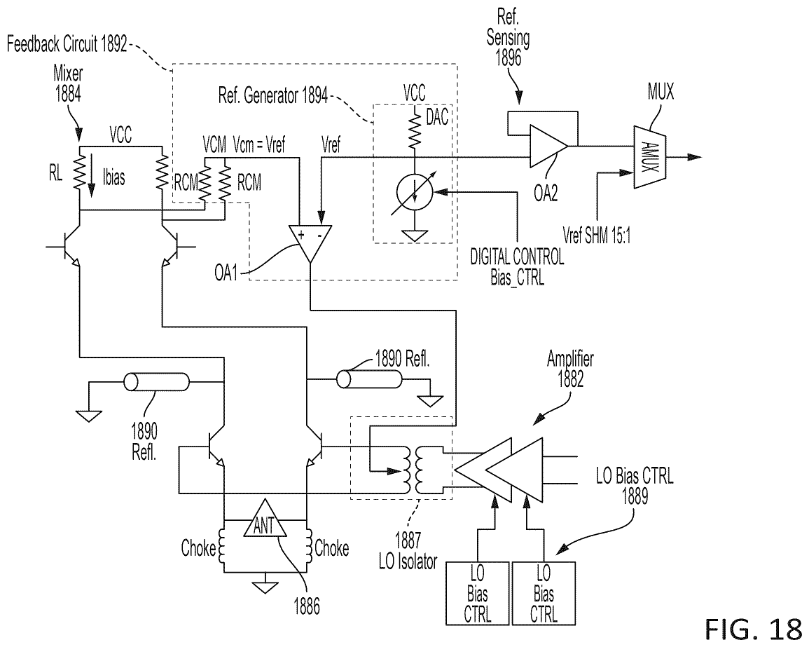

In some embodiments, frequency multiplier 1270 may include an input and/or output matching network. For example, as shown in FIG. 12A, frequency multiplier 1270 includes a matching network 1280 including inductors 1282 coupled to inputs 1272a and 1272b. In the illustrated example of FIG. 12A, inductors 1282 are coupled between amplifier 1233 and control terminals CTRL of transistor circuit 1276 to provide direct current (DC) coupling, though other DC-coupling circuit elements may be used such as resistors, transmission lines, and/or transformers (e.g., using a center-tap such as shown in FIG. 18).

While not shown in FIG. 12A, it should be appreciated that reference generator circuit 1234 may be configured to receive a bias control signal, such as to control current source I_ref and/or to control the resistance (e.g., when variable) of reference resistor R_ref of reference generator circuit 1234, on which reference voltage Vref may be based.

FIG. 12B illustrates the example frequency multiplier 1270 and feedback circuit 1232 of FIG. 12A with an alternative reference generator circuit 1234′ that may be included in the transmitters of FIGS. 9 and 10A-10B, in accordance with some embodiments of the technology described herein.

In some embodiments, reference generator circuit 1234′ may be configured to generate and provide reference voltage Vref to amplifier 1233 such as described herein for reference generator circuit 1234. For example, as shown in FIG. 12B, reference generator circuit 1234′ includes reference resistors R_ref1 and R_ref2. In some embodiments, reference resistors R_ref1 and R_ref2 may be configured as a resistive divider configured to produce reference voltage Vref based on a ratio of resistance values of reference resistors R_ref1 and R_ref2.

FIG. 12C illustrates the example frequency multiplier 1720 and feedback circuit 1232 of FIG. 12A with transformer-based matching networks 1280c that may be included in the transmitters of FIGS. 9 and 10A-10B, in accordance with some embodiments of the technology

In some embodiments, transformer-based matching networks 1280c may be configured to provide DC coupling between feedback circuit 1232 and inputs 1272a and 1272b of frequency multiplier 1270, such as described herein for matching network 1280. For example, as shown in FIG. 12C, a center-tap of a transformer-based matching network 1280c is coupled between an output of amplifier 1233 and inputs 1272a and 1272a of frequency multiplier 1270. In some embodiments, a transformer-based matching network 1280c may be further coupled to output 1274 of frequency multiplier 1270, such as shown in FIG. 12C.

FIG. 12D illustrates the example frequency multiplier 1270 and feedback circuit 1232 of FIG. 12A with inductive and capacitive matching networks 1280d that may be included in the transmitters of FIGS. 9 and 10A-10B, in accordance with some embodiments of the technology described herein.

In some embodiments, inductive and capacitive matching networks 1280c may be configured to provide DC coupling between feedback circuit 1232 and inputs 1272a and 1272b of frequency multiplier 1270, such as described herein for matching network 1280. For example, as shown in FIG. 12D, a center-tap of an inductor of a matching network 1280d is coupled between an output of amplifier 1233 and inputs 1272a and 1272a of frequency multiplier 1270, and AC coupling capacitors are further coupled to end taps of the center-tapped inductor. In some embodiments, an inductive matching network of inductive and capacitive matching networks 1280d may be further coupled to output 1274 of frequency multiplier 1270, such as shown in FIG. 12D as a T-network of inductors.

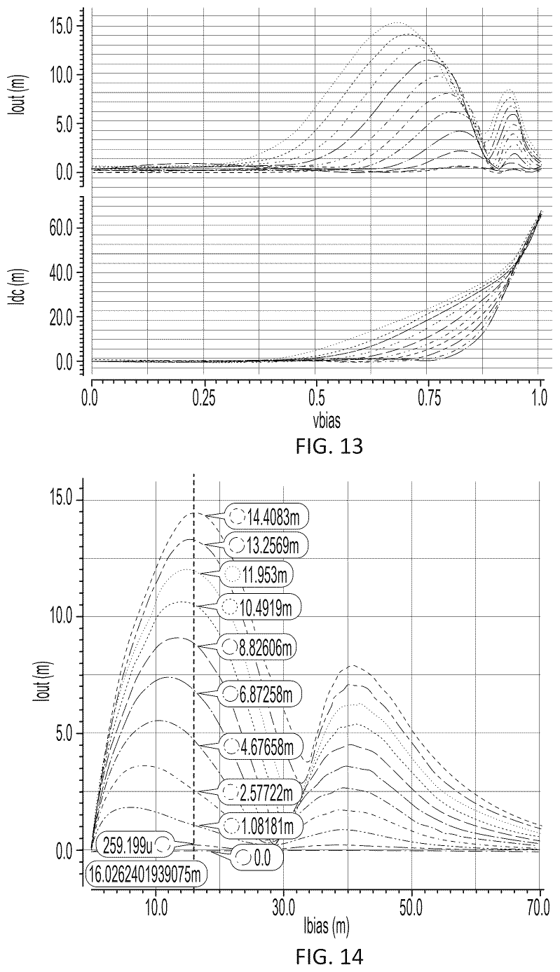

FIG. 13 illustrates example direct current (DC) channel current and second harmonic output current vs. bias voltage for frequency multiplier 1270, in accordance with some embodiments of the technology described herein. FIG. 13 includes a top plot, in which each curve corresponds to second harmonic output current in response to a different input power level (e.g., of a reference RF signal) as input to the control terminal of transistor circuit 1276 over a range of DC bias voltages (e.g., applied to the control terminal). FIG. 13 further includes a bottom plot, in which each curve corresponds to DC current flowing in the channel of transistor circuit 1276 in response to a different input power level (e.g., of the reference RF signal) as input to the control terminal over the range of DC bias voltages.

As shown in FIG. 13, transistor circuit 1276 of frequency multiplier 1270 may exhibit a peak second harmonic output current of about 15 Milliamps (mA), which may be due at least in part to conserving, at output 1274, at least some power from input base-emitter current used to switch transistor circuit 1276. In some embodiments, transistor circuit configurations described herein are more efficient than some other transistor configurations (e.g., common-emitter configurations) that lose a substantial amount of power at the first channel terminal (e.g., emitter or source) that is not converted to (e.g., second) harmonic output power.

FIG. 14 illustrates example second harmonic output current vs. DC channel current for frequency multiplier 1270, in accordance with some embodiments of the technology described herein. In FIG. 14, each curve corresponds to second harmonic output current in response to a different input power level (e.g., of a reference RF signal) as input to the control terminal of transistor circuit 1276 over a range of DC bias currents.

In some embodiments, transistor circuit 1276 of frequency multiplier 1270 may be configured to output a first peak harmonic current when transistor circuit 1276 is biased with a first bias current and output a second peak harmonic current that is lower than the first peak harmonic current when transistor circuit 1276 is biased with a second bias current that is higher than the first bias current. For example, as shown in FIG. 14, transistor circuit 1276 may output a first peak second harmonic current of about 14.4 mA when biased with a first bias current of about 16 mA and may output a second peak harmonic current of about 8 mA when biased with a second bias current of about 41 mA. In some embodiments, transistor circuit 1276 may provide efficient frequency multiplication by outputting a high harmonic current at a low DC bias point.

In some embodiments, the DC bias point (e.g., DC bias current in FIG. 14) may be selected to substantially align with peaks in harmonic currents output in response to various input power levels.

FIG. 15A illustrates a portion of an example transmitter that may be included in the radar device of FIG. 2, in accordance with some embodiments of the technology described herein. FIG. 15B illustrates example transmit circuitry that may be included in the transmitter of FIG. 15A, in accordance with some embodiments of the technology described herein.

In some embodiments, TX 1520 may be configured as described herein for transmit semiconductor die 1021 including in connection with FIGS. 10A-10B. For example, as shown in FIG. 15A, TX 1520 includes transmit semiconductor dies 1521a, 1521b, and 1521c, which are shown in FIG. 15A tiled in a first direction (e.g., the y-direction) and spaced from one another in the first direction. In the illustrated example, transmit semiconductor die 1521b includes transmit elements 1522 and antenna array 1532 arranged in first and second columns 1506a and 1506b. Also shown in FIG. 15A, transmit semiconductor die 1521b has a first interface 1550a at a first outer edge 1526a including bond pads 1556a, and a second interface 1550b at a second outer edge 1526b including bonds pads 1556b. For instance, in some embodiments, bond pads 1556a and 1556b may be wire bonded to a substrate (e.g., 1002 in FIG. 10A) such that antenna array 1532 faces away from the substrate. Though not shown in FIG. 15A, in some embodiments, first interface 1550a and second interface 1550b may each further include a frequency multiplier and a power divider, such as described herein for transmit semiconductor die 1021.

In some embodiments, transmit elements 1522 may be configured as described herein for transmit elements 1022 including in connection with FIGS. 10A-10B. For example, as shown in FIG. 15B, each transmit element 1522a, 1522b includes an antenna 1570 of antenna array 1532 and transmit circuitry 1560 including phase shifter 1562, amplifiers 1564, and frequency multiplier 1566 directly coupled to antenna 1570. In FIGS. 15A-15B, antennas 1570 are configured as patch antennas, which may be advantageous for transmitting and receiving circularly polarized RF signals to mitigate the impact of raindrops on reception, though other antenna configurations (e.g., dipoles) may be used.

### Receiver Architecture

FIG. 16A illustrates example signal generation circuitry 1650, interface circuitry 1640, processing circuitry 1610, and RX 1630 that may be included in a radar device, e.g., 1600 in FIG. 16A, in accordance with some embodiments of the technology described herein. FIG. 16B illustrates example receive circuitry 1680 that may be included in RX 1630, in accordance with some embodiments of the technology described herein.

In some embodiments, device 1600 may be configured as described herein for device 200 and/or 700 including in connection with FIGS. 2 and 7. For example, as shown in FIG. 16A, device 1600 includes substrate 1602 having mounted thereon signal generation circuitry 1650, RX 1630, interface circuitry 1640, and processing circuitry 1610.

In some embodiments, RX 1630 may have a receive semiconductor die with a receive antenna array and receive circuitry. For example, in FIG. 16A, RX 1630 includes receive semiconductor die 1631 including receive elements 1632 and receive antenna array 1639. For instance, each receive element 1632 may include an antenna (e.g., 1686 in FIG. 16B) of antenna array 1639 and receive circuitry 1680 configured to feed (e.g., obtain received RF signals via) the antenna.

In some embodiments, receive antenna array 1639 may have a receive aperture with a receive aperture length extending in a first direction (e.g., the y-direction) and a receive aperture width extending in a second direction (e.g., the x-direction), the receive aperture length being smaller than the receive aperture width. For example, as shown in FIG. 16A, antenna array 1639 has more antennas in the x-direction than in the y-direction, which pay provide a larger receive aperture length in the x-direction than receive aperture width in the y-direction.

In some embodiments, RX 1630 may be configured to obtain a reference RF signal from signal generation circuitry 1650. For example, as shown in FIG. 16A, receive semiconductor die 1631 further includes an input interface 1660 configured to receive a reference RF signal from signal generation circuitry 1650. For instance, the reference RF signal may be propagated from signal generation circuitry 1650 to receive semiconductor die 1631 via traces on substrate 1602 and provided to bond pads of input interface 1660. And, as further shown in FIG. 16B, interface 1660 includes a frequency multiplier 1662 and power divider 1664, which may be configured as described herein for frequency multiplier 1052a and power divider 1054a of transmit semiconductor die 1021, respectively, in some embodiments. For instance, frequency multiplier 1662 may be configured to up-convert the reference RF signal to a higher center frequency (e.g., from 17.22 GHz to 155 GHZ) for mixing with received RF signals, and power divider 1664 may be configured to divide the reference RF signal among multiple receive elements 1632 for providing to amplifiers 1682. In some embodiments, frequency multiplier 1662 may be configured to up-convert the reference RF signal to a center frequency lower than the center frequency of received RF signals, such as for mixing using a (e.g., sub-harmonic mixer) as described further herein. While not shown in FIG. 16B, it should be appreciated that power divider 1664 may be coupled to the receive elements 1632 of receive semiconductor die 1631 as described herein for the portion of device 1600 shown in FIG. 16B.

In some embodiments, receive circuitry 1680 may be configured to mix RF signals, received via antenna array 1639, with a reference RF signal. For example, as shown in FIG. 16B, receive element 1632 includes an antenna 1686 of antenna array 1639 and a portion of receive circuitry 1680 that includes a first amplifier 1682, a mixer 1684 coupled to antenna 1686, and a second amplifier 1688 coupled to mixer 1684. As further shown in FIG. 16B, receive circuitry 1680 of receive element 1632 includes feedback circuit 1692, which may be configured to regulate a bias state (e.g., bias current) of mixer 1684, such as described herein for feedback circuits 732 and 832 including in connection with FIGS. 7-8. In some embodiments, a feedback circuit 1692 may be included for each receive element 1632 of receive semiconductor die 1631.

In some embodiments, first amplifier 1682 may be configured to obtain and provide a reference RF signal to mixer 1684, such as described further below. In some embodiments, mixer 1684 may be configured to mix an RF signal, received via antenna 1686, with the reference RF signal obtained via first amplifier 1682 to output a mixed signal. In some embodiments, second amplifier 1688 may be configured to amplify and provide the mixed signal to an output interface 1670 of receive semiconductor die 1631 (e.g., for offloading via interface circuitry 1640).

In some embodiments, mixer 1684 may be configured to output the mixed signal having a center frequency indicative of a distance between device 1600 and a target object (e.g., 106 in FIG. 1) from which the received RF signal was received by antenna 1686. For example, the received RF signal and the reference RF signal may be LFM signals that, when mixed, produce a mixed signal having a center frequency indicating a time delay between transmission of an RF signal (e.g., based on the reference RF signal) and reception of the received RF signal, such as described herein including in connection with FIGS. 5-6. In some embodiments, mixer 1684 may be configured as a sub-harmonic mixer. For example, the reference RF signal obtained via amplifier 1682 may have a harmonic having the center frequency of the RF signal obtained via antenna 1686, and mixer 1684 may be configured to mix the RF signal obtained via antenna 1686 with that harmonic of the reference RF signal. For instance, mixer 1684 may be configured as a second sub-harmonic mixer configured to mix a second harmonic (e.g., center frequency of 310 GHz) of the reference RF signal (e.g., center frequency of 155 GHZ) with the RF signal (e.g., center frequency of 310 GHz) obtained via antenna 1686, though other sub-harmonics, such as even-integer sub-harmonics may be used.

In some embodiments, receive circuitry 1680 may further include a reflector coupled between a mixer and an amplifier and configured to reflect at least some RF energy generated by the mixer back into the mixer. For example, as shown in FIG. 16B, receive element 1632 further includes reflector 1690 coupled between mixer 1684 and amplifier 1688. In some embodiments, a reflector 1690 may be included for each antenna 1686 of antenna array 1639, such as between a mixer 1684 and amplifier 1688 of each receive element 1632 of receive semiconductor die 1631.

In some embodiments, including reflector 1690 in a receive element 1632 may improve the gain and/or efficiency of RX 1630. For example, reflector 1690 may be configured to reflect RF energy, at least at the first center frequency (of the RF signal received via antenna 1686) back into mixer 1684 to recycle at least some of the RF energy at the first center frequency into RF energy in the mixed signal output by mixer 1684, thereby increasing the gain and/or efficiency (e.g., output power vs. input power) of mixer 1684. In some embodiments, increases in gain and/or efficiency of mixers may thereby increase the sensitivity of the receiver to RF signals at low power levels (e.g., attenuated due to reception from farther away).

In some embodiments, interface circuitry 1640 may include AFE and/or ADC circuitry mounted on substrate 1602 and configured to receive mixed signals via RX 1630 (e.g., amplifier 1688). For example, interface circuitry 1640 may include AFE and/or ADC circuitry integrated on receive semiconductor die 1631, such as with the AFE circuitry coupled to amplifier 1688 on-die. Alternatively or additionally, AFE and/or ADC circuitry may be on one or more separate dies, such as a mixed-signal ASIC, and/or within an integrated circuit package with at least a portion of processing circuitry 1610.

While a single receive semiconductor die 1631 is shown in FIG. 16A, a device may have multiple receive semiconductor dies 1631 shown as configured in FIG. 16A, such as organized into one or more rows (e.g., as shown in FIG. 1). For example, receive semiconductor die 1631 may be a first die and device 1600 may further include a second receive semiconductor die configured as described herein for die 1631 and disposed in a row with the first die along the x-direction. For instance, each receive semiconductor die 1631 may be configured to obtain a reference RF signal from signal generation circuitry 1650.

While signal generation circuitry 1650 is shown on the same substrate 1602 as receive semiconductor die 1631 in FIG. 16A, signal generation circuitry 1650 may be on a separate substrate in some embodiments.

In some embodiments, device 1600 may further have a transmitter (e.g., 220 in FIG. 2) mounted on substrate 1602 and configured to receive the reference RF signal from signal generation circuitry 1650, generate RF signals using the reference RF signal (e.g., by up-converting and dividing the reference RF signals), and feed the RF signals to a plurality of RF transmit antennas.

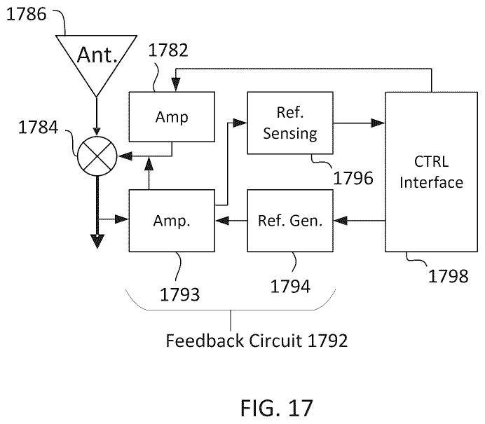

FIG. 17 illustrates an example antenna 1786, mixer 1784, amplifier 1782, and feedback circuit 1792 that may be included in RX 1630, in accordance with some embodiments of the technology described herein.

In some embodiments, antenna 1786, mixer 1784, and amplifier 1782 may be configured as described herein including in connection with FIGS. 16A-16B. For example, mixer 1784 may be configured to mix an RF signal, received via antenna 1786, with a reference RF signal obtained via first amplifier 1782 to output a mixed signal.

In some embodiments, feedback circuit 1792 may be configured as described herein for feedback circuits 732 and 832 including in connection with FIGS. 7-8. For example, feedback circuit 1792 may be configured to regulate a bias state of mixer 1784. For instance, in FIG. 17, feedback circuit 1792 is shown having an amplifier 1793 with an input coupled to (e.g., a channel terminal) of mixer 1784 and an output coupled to (e.g., a control terminal) of mixer 1784. In the illustrated example, feedback circuit 1792 further includes a reference generator circuit 1794, which may be configured to receive a bias control signal (e.g., Bias_CTRL in FIG. 8) and generate a reference voltage and/or current (e.g., Vref in FIG. 8) based thereon to provide to feedback circuit 1792. In some embodiments, reference generator circuit 1794 may be configured to receive the bias control signal from a control (CTRL) interface 1798 (e.g., a digital control interface). For example, where feedback circuit 1792, bias control circuit 1794, and control interface 1798 are implemented on a receive semiconductor die (e.g., 1631 in FIG. 16A), control interface 1798 may be configured to receive the signal from outside of the semiconductor die.

In some embodiments, feedback circuit 1794 may be further configured to provide a sensed reference voltage and/or current to the interface. For example, as shown in FIG. 17, feedback circuit 1794 is further coupled to a reference sensing circuit 1796, which may be configured to provide the sensed reference voltage and/or current to the control interface. For instance, a controller (e.g., within processing circuitry 210 in FIG. 2) may be configured to provide a bias control signal to control interface 1798 in response to the sensed reference voltage and/or current, such as in response to detecting that the sensed reference voltage and/or current is above or below a predetermined reference voltage and/or current (e.g., due to process variation and/or temperature fluctuation).

It should be appreciated that the feedback circuits 732, 832, and 1068 of FIGS. 7-8 and 10B may be alternatively or additionally coupled to a control interface such as described herein for feedback circuit 1794.

FIG. 18 illustrates another example antenna 1886, mixer 1884, amplifier 1882, and feedback circuit 1892 that may be included in RX 1630, in accordance with some embodiments of the technology described herein.

In some embodiments, antenna 1886, mixer 1884, and amplifier 1882 may be configured as described herein for antenna 1786, mixer 1784, and amplifier 1782 including in connection with FIG. 17. For example, as shown in FIG. 18, antenna is coupled to first channel terminals (e.g., emitters in FIG. 18) of transistors of mixer 1884, and amplifier 1882 is configured to drive control terminals of the transistors with a reference RF signal. In the illustrated example, amplifier 1882 is configured to receive local oscillator (LO) bias control signals from LO bias control circuit 1889, and amplifier 1882 is coupled to control terminals of mixer 1884 by an LO isolator 1887, which may be configured as an inductive transformer isolator.

In some embodiments, mixer 1884 may be further configured as described herein for mixer 1684 including in connection with FIG. 16B, such as including reflectors 1890, which may be configured as described herein for reflector 1690. For instance, in FIG. 18, reflectors 1890 may be configured as current reflectors, such as including quarter-wavelength transformers (e.g., having a center frequency of RF signals antenna 1886 is configured to receive).

In some embodiments, feedback circuit 1892 may be configured as described herein for feedback circuit 832 including in connection with FIG. 8. For example, as shown in FIG. 18, feedback circuit 1892 may be configured to regulate a channel current in a channel of a transistor circuit of mixer 1884 by controlling a control terminal of the transistor circuit. For instance, as shown in FIG. 18, mixer 1884 includes a differential transistor pair having bias currents I_Bias flowing in the channel of each transistor and with a control terminal coupled to feedback circuit 1892. In the illustrated example of FIG. 18, feedback circuit 1892 has an input (e.g., common mode resistors RCM) coupled to channel terminals of the transistor circuit of mixer 1884 and an output (e.g., of amplifier OA1) coupled (e.g., via a center tap of LO isolator 1887) to the control terminals of the transistor circuit.

In some embodiments, feedback circuit 1892 may be configured to obtain a reference voltage and/or current and regulate a bias state of mixer 1884 based on the reference voltage and/or current, such as described herein for feedback circuit 1792 including in connection with FIG. 17. For example, as shown in FIG. 18, feedback circuit 1892 includes a reference generator circuit 1894 configured to provide reference voltage Vref to amplifier OA1. For instance, feedback circuit 1892 may be further configured to receive a bias control signal Bias_CTRL and generate reference voltage Vref based on the bias control signal. In the illustrated example of FIG. 18, reference generator circuit 1894 includes a variable current source having a digital input that may be configured to draw current through a reference resistor to set reference voltage Vref based on a digital value of bias control signal Bias_CTRL.

While not shown in FIG. 18, in some embodiments, bias control signal Bias_CTRL may be received via a control interface (e.g., 1798). For example, as shown in FIG. 18, feedback circuit 1892 further includes a reference sensing circuit 1896 including an amplifier OA2 and a multiplexer MUX, which may be configured to provide a sensed reference voltage from reference generator circuit 1894 to the control interface, scuh as described herein including in connection with FIG. 17.

### Interface Circuitry

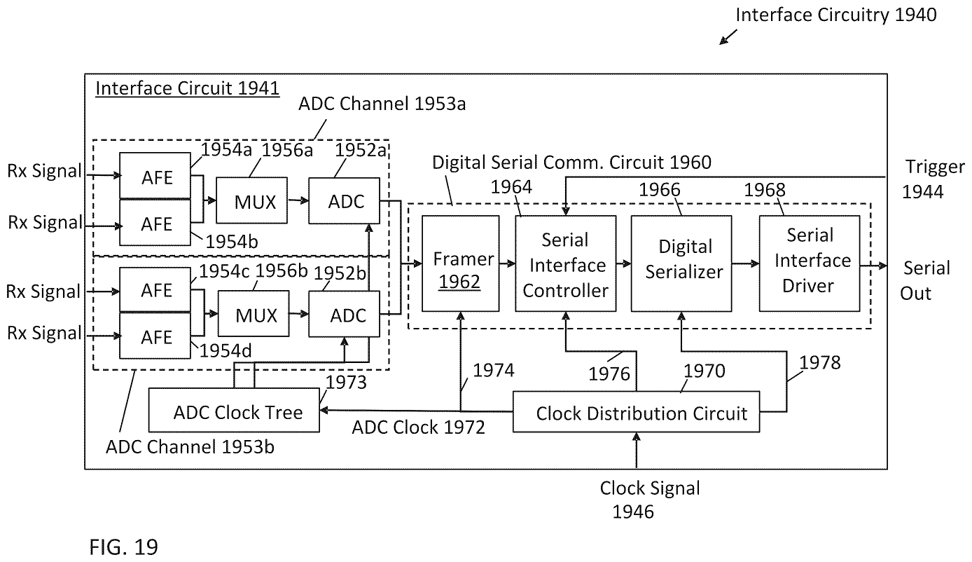

FIG. 19 illustrates example interface circuitry 1940 that may be included in radar device 200, in accordance with some embodiments of the technology described herein.

In some embodiments, interface circuitry 1940 may be configured as described herein for interface circuitry 240 including in connection with FIG. 2. As shown in FIG. 19, interface circuitry 1940 includes an interface integrated circuit 1941. For instance, as shown in FIG. 19, interface integrated circuit 1941 includes time-division multiplexing circuitry including first time-division multiplexer 1956a and second time-division multiplexer 1956b, as well as ADC circuitry including first ADC circuit 1952a and second ADC circuit 1952b.

In some embodiments, first time-division multiplexer 1956a may be coupled to first and second receive channels (e.g., 1632 in FIG. 16B) and configured to combine first and second processed RF signals, obtained from the first and second receive channels, into a first single time-division multiplexed signal, and second time-division multiplexer 1956b may be coupled to third and fourth receive channels and configured to combine third and fourth processed RF signals, obtained from the third and fourth receive channels, into a second single time-division multiplexed signal. In some embodiments, a time-division multiplexer may be included in the time-division multiplexing circuitry for each pair of receive channels that interface integrated circuit 1941 is coupled to (e.g., for each pair of receive channels of a receive semiconductor die, e.g., 1631, to which interface integrated circuit 1941 is coupled to). In some embodiments, time-division multiplexing a first number of receive channels into a second, lesser number of ADC channels may reduce power and space consumed in digitizing processed RF signals for routing and further downstream processing.

In some embodiments, operation of ADC circuitry of interface integrated circuit 1941 may be synchronized using a clock signal. For example, as shown in FIG. 19, interface integrated circuit 1941 includes a clock distribution circuit 1970 configured to receive clock signal 1946 (e.g., from processing circuitry, e.g., 210) and provide an ADC clock signal 1972 to the ADC circuitry via an ADC clock tree 1973. For instance, ADC clock tree 1973 may be configured to equalize propagation delays in ADC clock signal 1972 in conductive paths to respective ADC circuits (e.g., 1952a and 1952b) so as to synchronize sampling by the ADC circuitry.

In some embodiments, interface circuitry 1940 may further include amplification circuitry coupled between receive channels and the time-division multiplexing circuitry. For example, as shown in FIG. 19, interface circuitry 1940 further includes first analog front-end (AFE) circuitry 1954a, second AFE circuitry 1954b, third AFE circuitry 1954c, and fourth AFE circuitry 1954d, which may include amplification circuitry. For instance, first AFE circuitry 1954a may include a first amplifier coupled between a first receive channel and first time-division multiplexer 1956a and second AFE circuitry 1954b may include a second amplifier coupled between a second receive channel and first time-division multiplexer 1956a. Similarly, third AFE circuitry 1954c may include a third amplifier coupled between a third receive channel and second time-division multiplexer 1956b and fourth AFE circuitry 1954d may include a fourth amplifier coupled between a fourth receive channel and second time-division multiplexer 1956b. In some embodiments, each of AFE circuitry 1954a-1954d may include a high-pass filter, a preamplifier, a programmable-gain amplifier (PGA), an anti-aliasing filter, and a unity-gain buffer, though it should be appreciated that other configurations are possible.

In some embodiments, each of AFE circuitry 1954a-1954d may be configured to receive an intermediate frequency (IF) processed RF signal from a respective receive channel, such as having a bandwidth of less than 10 MHz (e.g., 5 MHz) and may be configured to provide the processed RF signal. In some embodiments, ADC circuits 1952a-1952b may be configured to perform digital sampling at a rate of 20 million samples per second (MSPs), though other ADC configurations are possible. In the illustrated example, first AFE circuitry 1954a, second AFE circuitry 1954b, first time-division multiplexer 1956a, and first ADC circuitry 1952a provide a first ADC channel 1953a, and third AFE circuitry 1954c, fourth AFE circuitry 1954d, second time-division multiplexer 1956b, and second ADC circuitry 1952b provide a second ADC channel 1953b.

As further shown in FIG. 19, interface integrated circuit 1941 includes digital serial communication circuitry 1960, which includes serial interface controller 1964 and framer 1962. In some embodiments, framer 1962 may be configured to provide a first frame (e.g., a single period of RF signal reception and/or a sequence of periods corresponding to a transmit scan) of first processed RF signals to serial interface controller 1964 in response to trigger signal 1944. For example, the first processed RF signals may be obtained from a first plurality of receive channels digitized via first ADC circuitry 1952a.

As further shown in FIG. 19, digital serial communication circuitry 1960 further includes a digital serializer 1966, which may be configured to combine a first single digitized time-division multiplexed signal (e.g., obtained from first ADC circuitry 1952a) a second single digitized time-division multiplexed signal (e.g., obtained from second ADC circuitry 1952b) into a single digital serial signal. For instance, digital serializer 1966 may be configured to obtain the digitized time-division multiplexed signals represented by respective groups of parallel digital bits and serialize the groups of parallel digital bits into a single digital bit stream. Also shown in FIG. 19, digital serial communication circuitry further includes a serial interface driver 1968, which may be configured to transmit the single digital serial signal from interface circuitry 1940 (e.g., via the substrate of the device). For example, serial interface driver 1968 may be configured to transmit the signal using a low-voltage differential signaling (LVDS) protocol.

In some embodiments, operation of digital serial communication circuitry 1960 may be synchronized using a clock signal. For example, as shown in FIG. 19, clock distribution circuit 1970 may be configured to provide clock signals 1974, 1976, and 1978 to framer 1962, serial interface controller 1964, and digital serializer 1966, respectively. For instance, clock signals 1974, 1976, and 1978 may have different clock rates, such as due to the higher clock rates that may be used for serialization as compared to framing digitized RF signals from the ADC circuitry.

While only a single interface integrated circuit 1941 is shown in FIG. 19, it should be appreciated that multiple interface integrated circuits 1941 may be included in a device (e.g., 200). For example, as shown in FIG. 19, interface integrated circuit 1941 may be configured to receive trigger signal 1944 and clock signal 1946, such as provided (e.g., by processing circuitry of the device) to multiple or all interface integrated circuits of the device to synchronize operation of interface circuitry 1940. For instance, each interface integrated circuit may be configured as described herein for interface integrated circuit 1941. In some embodiments, serialized processed RF signals offloaded from the interface integrated circuits may include data for one frame. For example, the processing circuitry may be configured to combine the serialized processed RF signals into a consolidated frame, such as to beamform processed RF signals serialized from respective receive channels of the receiver.

### Processing Circuitry

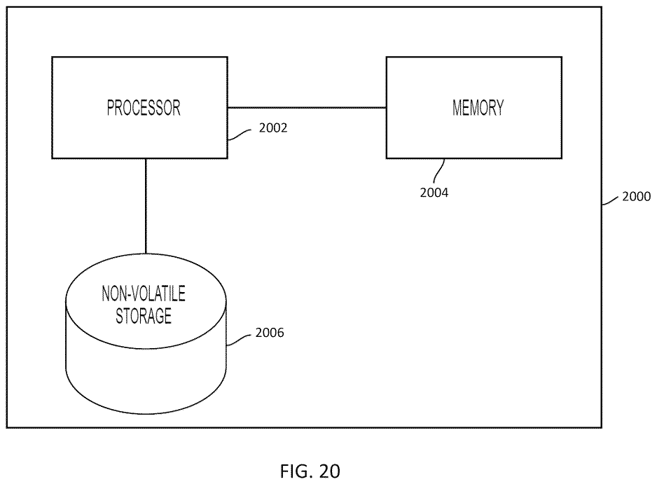

FIG. 20 illustrates an example computer system 2000 that may be configured to perform at least some processing operations in a radar device (e.g., 200 in FIG. 2), in accordance with some embodiments of the technology described herein.

An illustrative implementation of a computer system 2000 that may be used in connection with any of the embodiments of the disclosure provided herein is shown in FIG. 20. For example, in some embodiments, operations described herein including in connection with FIG. 1 may be performed using the computer system 2000 (e.g., implemented using processing circuitry mounted on and/or coupled to a substrate of a device). The computer system 2000 may include one or more processors 2002 and one or more articles of manufacture that comprise non-transitory computer-readable storage media (e.g., memory 2004 and one or more non-volatile storage media 2006). The processor 2002 may control writing data to and reading data from the memory 2004 and the non-volatile storage device 2006 in any suitable manner, as the aspects of the disclosure provided herein are not limited in this respect. To perform any of the functionality described herein, the processor 2002 may execute one or more processor-executable instructions stored in one or more non-transitory computer-readable storage media (e.g., the memory 2004), which may serve as non-transitory computer-readable storage media storing processor-executable instructions for execution by the processor 2002.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments can be implemented in any of numerous ways. One or more aspects and embodiments of the present disclosure involving the performance of processes or methods may utilize program instructions executable by a device (e.g., a computer, a processor, or other device) to perform, or control performance of, the processes or methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above. The computer readable medium or media can be transportable, such that the program or programs stored thereon can be loaded onto one or more different computers or other processors to implement various ones of the aspects described above. In some embodiments, computer readable media may be non-transitory media.

The terms “program” or “software” are used herein in a generic sense to refer to any type of computer code or set of computer-executable instructions that can be employed to program a computer or other processor to implement various aspects as described above. Additionally, it should be appreciated that according to one aspect, one or more computer programs that when executed perform methods of the present disclosure need not reside on a single computer or processor, but may be distributed in a modular fashion among a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within +20% of a target value in some embodiments, within +10% of a target value in some embodiments, within +5% of a target value in some embodiments, within +2% of a target value in some embodiments. The terms “approximately” and “about” may include the target value.

What is claimed is:

1. A device, comprising:
a substrate defining a plane extending in a first direction and a second direction that are substantially orthogonal to one another; and
a transmitter mounted on the substrate, the transmitter comprising:
a first transmit semiconductor die having integrated thereon:
first transmit circuitry configured to generate first RF signals having a first RF center frequency in a particular frequency range within a range of 300 GHz to 1.5 THz, the first transmit circuitry comprising:
a first frequency multiplier comprising an input, an output, and a transistor circuit, the transistor circuit comprising:
a control terminal configured to obtain a reference RF signal at the input;
a first channel terminal configured to generate a first RF signal of the first RF signals at the output having the first RF center frequency; and
a second channel terminal, wherein the control terminal and the first channel terminal are configured to control coupling between the first channel terminal and the second channel terminal; and
a first transmit antenna array comprising a first plurality of transmit RF antennas configured to transmit the first RF signals.

2. The device of claim 1, wherein:
the first frequency multiplier comprises a frequency doubler; and
the control terminal is configured to obtain the reference RF signal having a second RF center frequency that is one-half of the first RF center frequency.

3. The device of claim 1, wherein the first channel terminal is configured to generate the first RF signal as not inverted with respect to the reference RF signal the control terminal is configured to obtain at the input.

4. The device of claim 1, wherein the transistor circuit is configured to:
output a first peak harmonic current when the transistor circuit is biased with a first bias current; and
output a second peak harmonic current that is lower than the first peak harmonic current when the transistor circuit is biased with a second bias current that is higher than the first bias current.

5. The device of claim 1, wherein:
the transistor circuit comprises a heterojunction bipolar transistor (HBT) circuit comprising a base coupled to the input, an emitter coupled to the output, and a collector; and
the base and the emitter are configured to control coupling between the collector and the emitter.

6. The device of claim 1, further comprising signal generation circuitry mounted on the substrate and configured to generate the reference RF signal.

7. The device of claim 1, further comprising a receiver mounted on the substrate, the receiver comprising:
a first receive semiconductor die having integrated thereon:
a first receive antenna array comprising a first plurality of receive RF antennas configured to receive second RF signals having the first RF center frequency; and
first receive circuitry configured to mix the second RF signals with third RF signals, generated based on the reference RF signal, to obtain fourth RF signals.

8. The device of claim 7, further comprising processing circuitry mounted on the substrate and configured to determine, based on the fourth RF signals, a distance between the device and a target object that reflected the first RF signals to generate, at least in part, the second RF signals.

9. The device of claim 7, wherein the transmitter comprises a first column of transmit semiconductor dies, comprising the first transmit semiconductor die, that is tiled in the first direction, and wherein the receiver comprises a first row of receive semiconductor dies, comprising the first receive semiconductor die, that is tiled in the second direction.

10. The device of claim 1, wherein the first RF center frequency is between 300 GHz and 320 GHz.

11. The device of claim 1, wherein the first RF signals have a bandwidth of at least 2 GHz, at least 3 GHz, or at least 6 GHz.

12. A method for use with a device, the device comprising a substrate having a transmitter mounted thereon, the substrate defining a plane extending in a first direction and a second direction that are substantially orthogonal to one another, the transmitter comprising a first transmit semiconductor die having integrated thereon a first plurality of transmit RF antennas and first transmit circuitry, the first transmit circuitry comprising a first frequency multiplier comprising an input, an output, and a transistor circuit, and the transistor circuit comprising a control terminal, a first channel terminal, and a second channel terminal, the method comprising:
generating, using the first transmit circuitry, first RF signals having a first RF center frequency in a particular frequency range within a range of 300 GHz to 1.5 THz at least in part by:
obtaining, using the control terminal of the transistor circuit, a reference RF signal at the input of the first frequency multiplier;
generating, using the first channel terminal of the transistor circuit, a first RF signal of the first RF signals having the first RF center frequency at the output of the first frequency multiplier; and
controlling, using the control terminal and the first channel terminal, coupling between the first channel terminal and the second channel terminal; and
transmitting, using the first plurality of transmit RF antennas, the first RF signals.

13. The method of claim 12, wherein:
the first frequency multiplier comprises a frequency doubler; and
the control terminal of the transistor circuit obtains the reference RF signal having a second RF center frequency that is one-half of the first RF center frequency.

14. The method of claim 12, wherein the first channel terminal generates the first RF signal as not inverted with respect to the reference RF signal the control terminal obtains at the input.

15. The method of claim 12, wherein:
the transistor circuit comprises a heterojunction bipolar transistor (HBT) circuit comprising a base coupled to the input, an emitter coupled to the output, and a collector; and
controlling coupling between the first channel terminal and the second channel terminal comprises, using the base and the emitter, controlling coupling between the collector and the emitter.

16. The method of claim 12, wherein:
the device further comprises a receiver mounted on the substrate, the receiver comprising a first receive semiconductor die having integrated thereon a first receive antenna array and first receive circuitry, the first receive antenna array comprising a first plurality of receive RF antennas; and
the method further comprises:
receiving, using the first plurality of receive RF antennas, second RF signals having the first RF center frequency; and
mixing, using the first receive circuitry, the second RF signals with third RF signals, generated based on the reference RF signal, to obtain fourth RF signals.

17. The method of claim 16, wherein:
the device further comprises processing circuitry mounted on the substrate; and
the method further comprises determining, using the processing circuitry, based on the fourth RF signals, a distance between the device and a target object that reflected the first RF signals to generate, at least in part, the second RF signals.

18. The method of claim 12, wherein the first RF center frequency is between 300 GHz and 320 GHz.

19. The method of claim 12, wherein the first RF signals have a bandwidth of at least 2 GHZ, at least 3 GHz, or at least 6 GHz.

20. A device, comprising:
a substrate defining a plane extending in a first direction and a second direction that are substantially orthogonal to one another;
signal generation circuitry mounted on the substrate and configured to generate a reference RF signal;
a transmitter mounted on the substrate, the transmitter comprising:
a first transmit semiconductor die having integrated thereon:
first transmit circuitry configured to generate first RF signals having a first RF center frequency in a particular frequency range within a range of 300 GHz to 1.5 THz, the first transmit circuitry comprising:
a first frequency multiplier comprising an input, an output, and a transistor circuit comprising:
a control terminal configured to obtain a second reference RF signal, generated based on the reference RF signal, at the input;
a first channel terminal configured to generate a first RF signal of the first RF signals at the output having the first RF center frequency; and
a second channel terminal, wherein the control terminal and the first channel terminal are configured to control coupling between the first channel terminal and the second channel terminal; and
a first transmit antenna array comprising a first plurality of transmit RF antennas configured to transmit the first RF signals;
a receiver mounted on the substrate, the receiver comprising:
a first receive semiconductor die having integrated thereon:
a first receive antenna array comprising a first plurality of receive RF antennas configured to receive second RF signals having the first RF center frequency; and
first receive circuitry configured to mix the second RF signals with third RF signals, generated based on the reference RF signal, to obtain fourth RF signals;
interface circuitry mounted on the substrate and coupled to the first receive circuitry, the interface circuitry comprising analog-to-digital conversion (ADC) circuitry configured to digitize the fourth RF signals to obtain digitized fourth RF signals; and
processing circuitry mounted on the substrate and coupled to the interface circuitry, the processing circuitry configured to determine, based on the digitized fourth RF signals, a distance between the device and a target object that reflected the first RF signals to generate, at least in part, the second RF signals.
